(19) United States
(12) Patent Application Publication
(10) Pub. No.: US 2026/0304515 A1
(43) Pub. Date: Oct. 1, 2026

(54) METHOD AND APPARATUS FOR SUPPORTING LINK ESTABLISHMENT PROCEDURE WITH INTEGRATED DISCOVERY FOR UE-TO-UE RELAY COMMUNICATION IN A WIRELESS COMMUNICATION SYSTEM

(71) Applicant: ASUS Technology Licensing Inc., Taipei City (TW)

(72) Inventors: Chen-Hsiang Hung, Taipei City (TW); Li-Te Pan, Taipei City (TW)

(21) Appl. No.: 19/570,521

(22) Filed: Mar. 18, 2026

Related U.S. Application Data
(60) Provisional application No. 63/778,925, filed on Mar. 27, 2025.

(51) Int. Cl. H04W 76/14; H04W 28/02; H04W 76/23; H04W 88/04

(52) U.S. Cl. CPC H04W 76/14; H04W 28/0215; H04W 76/23; H04W 88/04

(57) ABSTRACT

A method and device for a relay User Equipment (UE) are disclosed. The relay UE establishes a direct link with a second end UE for supporting a UE-to-UE (U2U) relay communication between a first end UE and the second end UE via the relay UE. The relay UE, after establishing the direct link between the relay UE and the second end UE, sends a first message to the first end UE to trigger security establishment between the first end UE and the relay UE. The relay UE receives a second message from the first end UE to establish a security context between the relay UE and the first end UE or to add new PC5 Quality of Service (QoS) information, wherein the second message includes a first PC5 QoS information for supporting the U2U relay communication and a Medium Access Control (MAC) address of the first end UE.

### CROSS-REFERENCE TO RELATED APPLICATIONS

The present application claims the benefit of U.S. Provisional Patent Application Ser. No. 63/778,925 filed on Mar. 27, 2025, the entire disclosure of which is incorporated herein in its entirety by reference.

### FIELD

This disclosure generally relates to wireless communication networks, and more particularly, to a method and apparatus for supporting link establishment procedure with integrated discovery for UE-to-UE relay communication in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for a relay User Equipment (UE) are disclosed. In one embodiment, the relay UE establishes a direct link with a second end UE for supporting a UE-to-UE (U2U) relay communication between a first end UE and the second end UE via the relay UE. Furthermore, the relay UE, after establishing the direct link between the relay UE and the second end UE, sends a first message to the first end UE to trigger security establishment between the first end UE and the relay UE. The relay UE also receives a second message from the first end UE to establish a security context between the relay UE and the first end UE or to add new PC5 Quality of Service (QoS) information, wherein the second message includes a first PC5 QoS information for supporting the U2U relay communication and a Medium Access Control (MAC) address of the first end UE. In addition, the relay UE, in response to receiving the first PC5 QoS information, sends a third message to the second end UE for modifying or updating the direct link, wherein the third message includes a second PC5 QoS information for supporting the U2U relay communication and the MAC address of the first end UE included in the second message.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 6.7.1.1-1 of 3GPP TS 23.304 V18.7.0.

FIG. 6 is a reproduction of FIG. 6.7.3.2-1 of 3GPP TS 23.304 V18.7.0.

FIG. 7 is a reproduction of FIG. 7.2.3.2.1 of 3GPP TS 24.554 V18.8.0.

FIG. 8 is a reproduction of FIG. 7.2.3.2.2 of 3GPP TS 24.554 V18.8.0.

FIG. 9 is a reproduction of Table 10.3.2.1.1 of 3GPP TS 23.554 V18.8.0.

FIG. 10 is a reproduction of Table 10.3.6.1.1 of 3GPP TS 23.554 V18.8.0.

FIG. 11 is a reproduction of Table 10.3.14.1.1 of 3GPP TS 23.554 V18.8.0.

FIG. 12 illustrates exemplary exchanging MAC address for relay communication without integrated discovery according to one exemplary embodiment.

FIG. 13 illustrates exemplary exchanging MAC address for relay communication with integrated discovery according to one exemplary embodiment.

FIG. 14 is a message flow diagram according to one exemplary embodiment

FIG. 15 is a message flow diagram according to one exemplary embodiment.

FIG. 16 is a flow chart according to one exemplary embodiment.

FIG. 17 is a message flow diagram according to one exemplary embodiment.

FIG. 18 is a message flow diagram according to one exemplary embodiment.

FIG. 19 is a flow chart according to one exemplary embodiment.

FIG. 20 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: 3GPP TS 23.304 V18.7.0, “Proximity based Services (ProSe) in the 5G System (5GS) (Release 18)”; and 3GPP TS 24.554 V18.8.0, “Proximity-services (ProSe) in 5G System (5GS) protocol aspects (Release 18)”

The standards and documents listed above are hereby expressly incorporated by reference in their entirety.

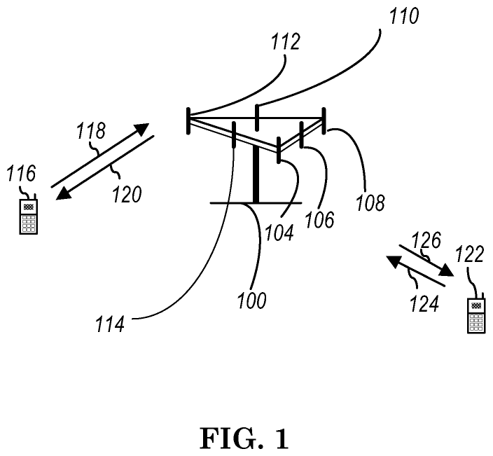

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

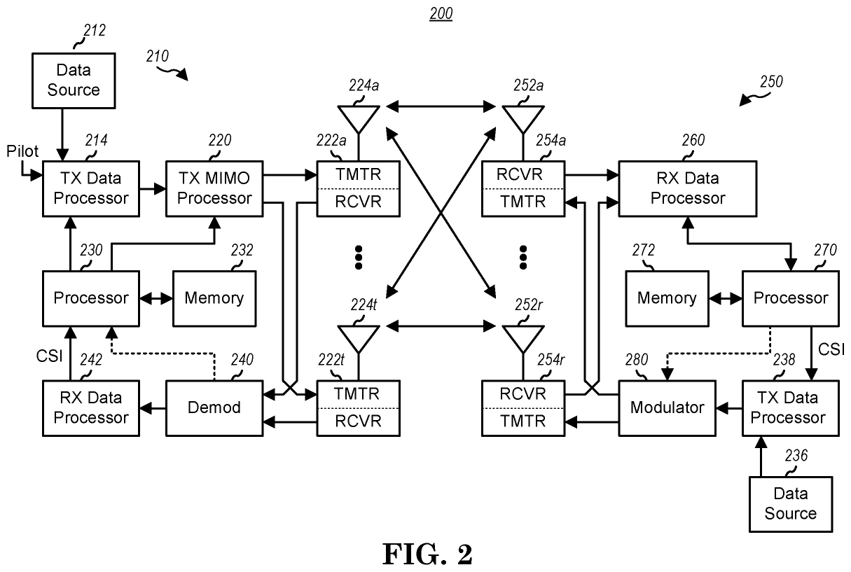

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides Nr modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from Nr antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

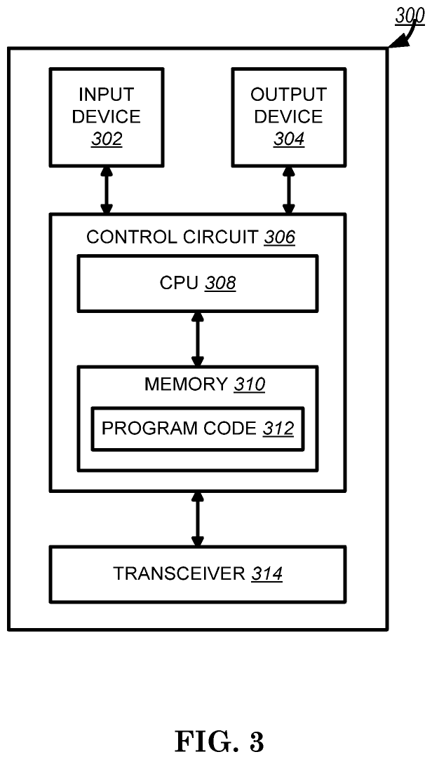

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

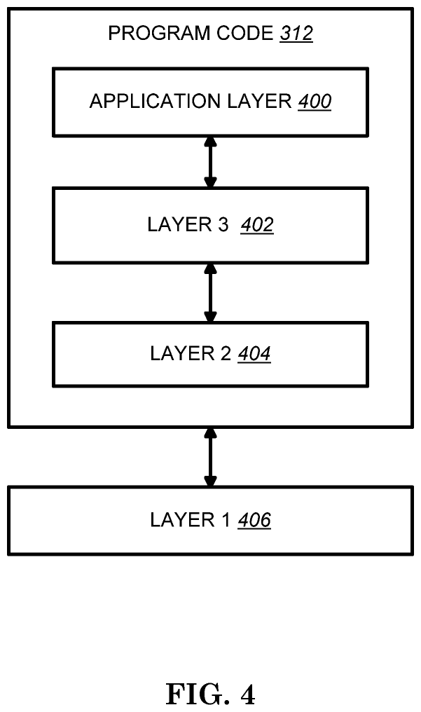

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 23.304 introduced the following:

### 6.4.3.7.1 Common Part for Layer-2 Link Management Over PC5 Reference Point for 5G ProSe UE-to-UE Relay

For the 5G ProSe Communication via 5G ProSe UE-to-UE Relay as described in clause 6.7.1 and clause 6.7.2:
The Direct Communication Request message over the first hop PC5 reference point includes:
   user info (i.e. Application Layer ID) of source 5G ProSe End UE: the identity of the source 5G ProSe End UE requesting relay operation.
   User Info ID of 5G ProSe UE-to-UE Relay: the identity of the UE-to-UE Relay provided to the source 5G ProSe End UE during 5G ProSe UE-to-UE Relay Discovery procedure.
   user info (i.e. Application Layer ID) of target 5G ProSe End UE: the identity of the target 5G ProSe End UE provided to the source 5G ProSe End UE during UE-to-UE Relay Discovery procedure.
   (optional) Destination Layer-2 ID of target 5G ProSe End UE: the unicast destination Layer-2 ID of the target 5G ProSe End UE determined by the source 5G ProSe End UE as specified in clause 5.8.2.4.
   ProSe Service Info: the information about the ProSe identifier(s) requesting Layer-2 link establishment.
   RSC: the connectivity service provided by the 5G ProSe UE-to-UE Relay as requested by the source 5G ProSe End UE.
   Security Information: the information for the establishment of security for the first hop PC5 link establishment (see TS 33.503 [29]).
      The Direct Communication Request message over the second hop PC5 reference point includes:
user info (i.e. Application Layer ID) of source 5G ProSe End UE.
user info (i.e. Application Layer ID) of target 5G ProSe End UE.
User Info ID of 5G ProSe UE-to-UE Relay.
ProSe Service Info: the information about the ProSe identifier(s).
RSC: the connectivity service provided by the 5G ProSe UE-to-UE Relay as requested by the source 5G ProSe End UE.
Security Information: the information for the establishment of security for the second hop PC5 link establishment (see TS 33.503 [29]).
   The Direct Communication Accept message over the second hop PC5 reference point includes:
user info (i.e. Application Layer ID) of target 5G ProSe End UE.
   The Direct Communication Accept message over the first hop PC5 reference point includes:
user info (i.e. Application Layer ID) of target 5G ProSe End UE.
User Info ID of 5G ProSe UE-to-UE Relay.
   The Link Modification Request message over the first hop PC5 reference point includes:
user info (i.e. Application Layer ID) of target 5G ProSe End UE: the identity of the target 5G ProSe End UE provided to the source 5G ProSe End UE during UE-to-UE Relay Discovery procedure.
(optional) Destination Layer-2 ID of target 5G ProSe End UE: the unicast destination Layer-2 ID of the target 5G ProSe End UE determined by the source 5G ProSe End UE as specified in clause 5.8.2.4.
   The Link Modification Request message over the second hop PC5 reference point includes:
user info (i.e. Application Layer ID) of source 5G ProSe End UE.
user info (i.e. Application Layer ID) of target 5G ProSe End UE.
   The Link Modification Accept message over the second hop PC5 reference point includes:
user info (i.e. Application Layer ID) of target 5G ProSe End UE.
   The Link Modification Accept message over the first hop PC5 reference point includes:
user info (i.e. Application Layer ID) of target 5G ProSe End UE.
   Each end-to-end unicast link for 5G Layer-2 ProSe UE-to-UE Relay is associated with a Unicast Link Profile, which includes:
user info (i.e. Application Layer ID) and Layer-2 ID of source 5G ProSe End UE; and
user info (i.e. Application Layer ID) and Layer-2 ID of target 5G ProSe End UE; and
Relay Service Code; and
information about PC5 QoS Flow(s).
   Each PC5 unicast link for 5G Layer-3 ProSe UE-to-UE Relay over the first hop is associated with a Unicast Link Profile, which includes:
user info (i.e. Application Layer ID) and Layer-2 ID of the 5G ProSe End UE; and
User Info ID and Layer-2 ID of 5G ProSe UE-to-UE Relay; and
Relay Service Code; and
the network layer protocol and the information about PC5 QoS Flow(s).
   Each PC5 unicast link for 5G Layer-3 ProSe UE-to-UE Relay over the second hop is associated with a Unicast Link Profile, which includes:
User Info ID and Layer-2 ID of 5G ProSe UE-to-UE Relay; and
user info (i.e. Application Layer ID) and Layer-2 ID of the 5G ProSe End UE; and
Relay Service Code; and
the network layer protocol and the information about PC5 QoS Flow(s).
   The Unicast Link Profile shall be updated accordingly after a Layer-2 link modification or Layer-2 link identifier update.
   [ . . . ]

### 6.4.3.7.3 Layer-2 Link Management Over PC5 Reference Point for 5G ProSe Layer-3 UE-to-UE Relay

For the 5G ProSe Communication via 5G ProSe Layer-3 UE-to-UE Relay as described in clause 6.7.1, the description in clause 6.4.3.7.1 applies with following differences and clarifications:
In the Security Procedure of the first hop PC5 reference point, the source 5G ProSe Layer-3 End UE provides the IP Address Configuration or Link-Local IPV6 Address and QoS Info of the end-to-end QoS to the 5G ProSe Layer-3 UE-to-UE Relay. If the PC5 link is used for transferring Ethernet traffic, the source 5G ProSe Layer-3 End UE provides its Ethernet MAC address instead of IP related information.
In the Security Procedure of the second hop PC5 reference point, the 5G ProSe Layer-3 UE-to-UE Relay provides the IP Address Configuration or Link-Local IPV6 Address and Qos Info of the second hop QoS to the target 5G ProSe End UE. If the PC5 link is used for transferring Ethernet traffic, the 5G ProSe Layer-3 UE-to-UE Relay provides the Ethernet MAC address of the source 5G ProSe Layer-3 End UE instead of IP related information.
The Direct Communication Accept message over the second hop PC5 reference point additionally includes IP Address Configuration or Link-Local IPV6 Address and QoS Info of the second hop QoS. If the PC5 link is used for transferring Ethernet traffic, the target 5G ProSe Layer-3 End UE provides its Ethernet MAC address instead of IP related information.
The 5G ProSe Layer-3 UE-to-UE Relay decides the QoS Info of the first hop QoS with considering the received second hop QoS, the Direct Communication Accept message over the first hop PC5 reference point additionally includes IP Address Configuration or Link-Local IPV6 Address, QoS Info of the first hop QoS and may include IP address of the target 5G ProSe End UE. If the PC5 link is used for transferring Ethernet traffic, 5G ProSe Layer-3 UE-to-UE Relay provides the Ethernet MAC address of the target 5G ProSe Layer-3 End UE instead of IP related information.
For adding new end-to-end QoS flow or modifying existing end-to-end QoS flow, in the Link Modification Request message over the first hop PC5 reference point, the source 5G ProSe End UE additionally includes QoS Info of the end-to-end QoS as described in the clause 6.4.3.4. For removing end-to-end QoS flows(s), in the Link Modification Request message over the first hop PC5 reference point, the source 5G ProSe End UE includes PFI(s) of the QoS flow(s) of the first hop as described in the clause 6.4.3.4. If the PC5 link is used for transferring Ethernet traffic, the source 5G ProSe Layer-3 End UE may provide its Ethernet MAC address.
For adding new end-to-end QoS flow or modifying existing end-to-end QoS flow, in the Link Modification Request message over the second hop PC5 reference point, the 5G ProSe Layer-3 UE-to-UE Relay additionally includes QoS Info of the second hop QoS to the target 5G ProSe End UE. For removing end-to-end QoS flow(s), in the Link Modification Request message over the second hop PC5 reference point, the 5G ProSe Layer-3 UE-to-UE Relay includes PFI(s) of the QoS flow(s) of the second hop. If the PC5 link is used for transferring Ethernet traffic, the 5G ProSe Layer-3 UE-to-UE Relay provides the Ethernet MAC address of the source 5G ProSe Layer-3 End UE.
For adding new end-to-end QoS flow or modifying existing end-to-end QoS flow, the Link Modification Accept message over the second hop PC5 reference point additionally includes QoS Info of the second hop QoS. If the PC5 link is used for transferring Ethernet traffic, the target 5G ProSe Layer-3 End UE may provide its Ethernet MAC address.
For adding new end-to-end QoS flow or modifying existing end-to-end QoS flow, the 5G ProSe Layer-3 UE-to-UE Relay decides the QoS Info of the first hop QoS with considering the received second hop QoS, the Link Modification Accept message over the first hop PC5 reference point additionally includes QoS Info of the first hop QoS and may include IP address of the target 5G ProSe End UE. If the PC5 link is used for transferring Ethernet traffic, 5G ProSe Layer-3 UE-to-UE Relay provides the Ethernet MAC address of the target 5G ProSe Layer-3 End UE instead of IP related information.
   When the PC5 link between a 5G ProSe Layer-3 End UE and the 5G ProSe Layer-3 UE-to-UE Relay is released, the 5G ProSe Layer-3 UE-to-UE Relay may initiate the PC5 link release to the peer 5G ProSe Layer-3 End UE(s) or notify the peer 5G ProSe Layer-3 End UE(s) the peer PC5 link is released.
   6.4.3.7.4 Layer-2 Link Management Over PC5 Reference Point for 5G ProSe UE-to-UE Relay Communication with Integrated Discovery
   This clause is for the 5G ProSe UE-to-UE Relay Communication with integrated Discovery procedure as described in clause 6.7.3.
   The Direct Communication Request message over the first hop PC5 reference point includes:
user info (i.e. Application Layer ID) of source 5G ProSe End UE.
(optional) user info (i.e. Application Layer ID) of target 5G ProSe End UE: the identity of the target 5G ProSe End UE if provided from the ProSe application layer.
(optional) Destination Layer-2 ID of target 5G ProSe End UE: the unicast destination Layer-2 ID of the target 5G ProSe End UE determined by the source 5G ProSe End UE as specified in clause 5.8.2.4.
ProSe Service Info: the information about the ProSe identifier(s) requesting Layer-2 link establishment.
RSC: the connectivity service provided by the 5G ProSe UE-to-UE Relay as requested by the source 5G ProSe End UE.
Relay_indication: indicates whether a 5G ProSe UE-to-UE Relay can send a Direct Communication Request message based on the received Direct Communication Request message which contains the relay_indication.
Security Information: the information for the establishment of security for the first hop PC5 link establishment (see TS 33.503 [29]).
   The Direct Communication Request message over the second hop PC5 reference point includes:
user info (i.e. Application Layer ID) of source 5G ProSe End UE.
User Info ID of 5G ProSe UE-to-UE Relay.
(optional) user info of target 5G ProSe End UE.
ProSe Service Info: the information about the ProSe identifier(s).
RSC: the connectivity service provided by the 5G ProSe UE-to-UE Relay as requested by the source 5G ProSe End UE.
Security Information: the information for the establishment of security for the second hop PC5 link establishment (see TS 33.503 [29]).
   The Direct Communication Accept message over the second hop PC5 reference point includes:
user info (i.e. Application Layer ID) of target 5G ProSe End UE.
   The Direct Communication Accept message over the first hop PC5 reference point includes:
user info (i.e. Application Layer ID) of target 5G ProSe End UE.
User Info ID of 5G ProSe UE-to-UE Relay.
   For the 5G ProSe Communication via 5G ProSe Layer-3 UE-to-UE Relay, additional clarifications are as following:
In the Security Procedure of the second hop PC5 reference point, the 5G ProSe Layer-3 UE-to-UE Relay provides the IP Address Configuration or Link-Local IPv6 Address to the target 5G ProSe End UE.
The Direct Communication Accept message over the second hop PC5 reference point additionally includes IP Address Configuration or Link-Local IPV6 Address (if IP communication is used), Ethernet MAC address of target 5G ProSe End UE (if Ethernet communication is used). QoS Info is not included in the Security Procedure or Direct Communication Accept message of the second hop PC5 reference point.
In the Security Procedure of the first hop PC5 reference point, the source 5G ProSe End UE provides the IP Address Configuration, Link-Local IPV6 Address and QoS Info of the end-to-end QoS to the 5G ProSe Layer-3 UE-to-UE Relay.
The 5G ProSe Layer-3 UE-to-UE Relay provides the QoS info of the second hop QoS to the target 5G ProSe End UE using the Layer-2 link modification as described in the clause 6.4.3.4.
The 5G ProSe Layer-3 UE-to-UE Relay decides the QoS Info of the first hop QoS with considering the received second hop QoS from the target 5G ProSe End UE, the Direct Communication Accept message over the first hop PC5 reference point additionally includes IP Address Configuration or Link-Local IPV6 Address, QoS Info of the first hop Qos and may include IP address of the target 5G ProSe End UE (if IP communication is used) or Ethernet MAC address of target 5G ProSe End UE (if Ethernet communication is used).
   For the 5G ProSe Communication via 5G ProSe Layer-2 UE-to-UE Relay, the message contents over PC5 reference point for unicast mode 5G ProSe Direct Communication as depicted from clause 6.4.3.1 to clause 6.4.3.5 are same for the end-to-end connection between peer 5G ProSe End UEs.
   [ . . . ]

### 6.7.1 5G ProSe Communication Via 5G ProSe Layer-3 UE-to-UE Relay

### 6.7.1.1 Layer-2 Link Establishment for PC5 Communication Via 5G ProSe Layer-3 UE-to-UE Relay

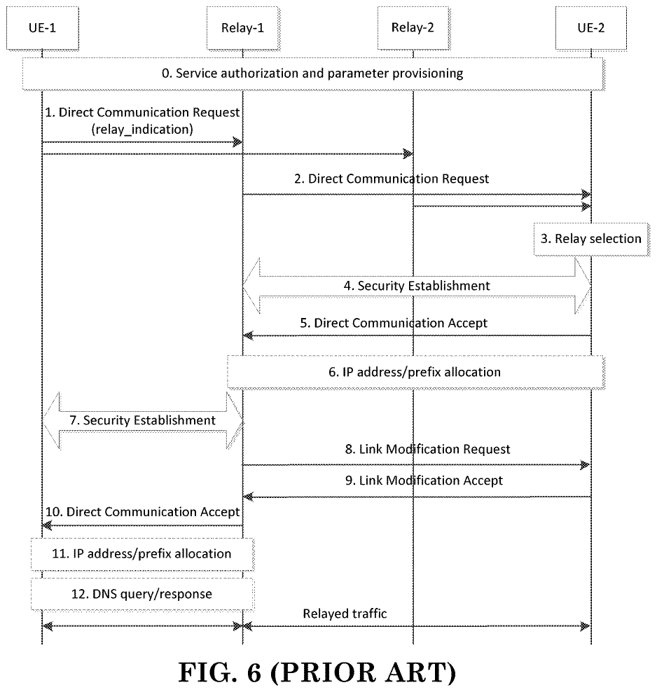

FIG. 6.7.1.1-1 shows the procedure for Layer-2 link establishment via 5G ProSe Layer-3 UE-to-UE Relay.

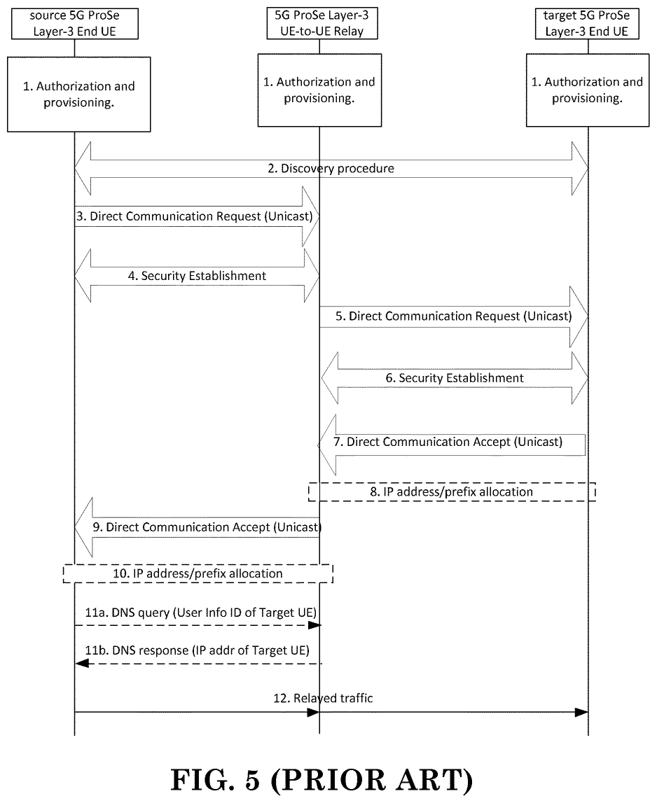

### [FIG. 6.7.1.1-1 of 3GPP TS 23.304 V18.7.0, Entitled “Layer-2 Link Establishment Via 5G ProSe Layer-3 UE-to-UE Relay”, is Reproduced as FIG. 5]

1. Service authorization and provisioning are performed for source 5G ProSe Layer-3 End UE, target 5G ProSe Layer-3 End UE and 5G ProSe Layer-3 UE-to-UE Relay as described in clause 6.2.
2. The source 5G ProSe Layer-3 End UE performs discovery of a 5G ProSe Layer-3 UE-to-UE Relay as described in clause 6.3.2.4.
3. The source 5G ProSe Layer-3 End UE sends a Direct Communication Request message to initiate the unicast Layer-2 link establishment procedure with the 5G ProSe Layer-3 UE-to-UE Relay. The parameters included in the Direct Communication Request message are described in clause 6.4.3.7.
   The Source Layer-2 ID of the Direct Communication Request message is self-assigned by the source 5G ProSe Layer-3 End UE and the Destination Layer-2 ID is set to the Source Layer-2 ID of the discovery message of the 5G ProSe Layer-3 UE-to-UE Relay.
   The source 5G ProSe Layer-3 End UE gets application information and optional ProSe Application Requirements from ProSe application layer, and determines the end-to-end QoS parameters as described in clause 5.6.3.1.
4. If the User Info ID of 5G ProSe Layer-3 UE-to-UE Relay in the Direct Communication Request message matches the 5G ProSe UE-to-UE Relay's User Info ID and the RSC in the Direct Communication Request matches one RSC that the relay is (pre) configured with, as specified in clause 5.1.5.1, the 5G ProSe Layer-3 UE-to-UE Relay responds by establishing the security with the source 5G ProSe Layer-3 End UE. When the security protection is enabled, the source 5G ProSe Layer-3 End UE sends the parameters as described in clause 6.4.3.7 to the 5G ProSe Layer-3 UE-to-UE Relay.
   If the Ethernet MAC address of source 5G ProSe Layer-3 End UE is already used by another 5G ProSe Layer-3 End UE, then the 5G ProSe Layer-3 UE-to-UE Relay rejects the direct link establishment indicating that the MAC address is not unique.
   The Source Layer-2 ID used for the security establishment procedure is self-assigned by the 5G ProSe Layer-3 UE-to-UE Relay and the Destination Layer-2 ID is set to the Source Layer-2 ID of the received Direct Communication Request message.
   The 5G ProSe Layer-3 UE-to-UE Relay shall choose different Source Layer-2 IDs for PC5 links of different types of traffic, i.e., IP traffic, Ethernet traffic and Unstructured traffic. If the PC5 link is used for transferring Unstructured traffic, the 5G ProSe Layer-3 UE-to-UE Relay shall choose different Source Layer-2 IDs for different pair of source and target 5G ProSe Layer-3 End UEs.
   Upon receiving the security establishment procedure messages, the source 5G ProSe Layer-3 End UE obtains the 5G ProSe Layer-3 UE-to-UE Relay's Layer-2 ID for future communication, for signalling and data traffic for this unicast link.
5. After the Security Establishment procedure in step 4 is completed, the 5G ProSe Layer-3 UE-to-UE Relay decides whether to use an existing unicast Layer-2 link between itself and the target 5G ProSe End UE for the required service. If there is no existing unicast Layer-2 link of the required RSC with the target 5G ProSe Layer-3 End UE, the 5G ProSe Layer-3 UE-to-UE Relay sends a Direct Communication Request message to initiate the unicast Layer-2 link establishment procedure with the target 5G ProSe Layer-3 End UE. The parameters included in the Direct Communication Request message are described in clause 6.4.3.7.
   The Source Layer-2 ID of the Direct Communication Request message is self-assigned by the 5G ProSe Layer-3 UE-to-UE Relay and the Destination Layer-2 ID may be broadcast or unicast Layer-2 ID. Unicast Layer-2 ID is used only if the Layer-2 ID of the target 5G ProSe Layer-3 End UE associated with the user info (i.e. Application Layer ID) is known to the 5G ProSe Layer-3 UE-to-UE Relay.
   The 5G ProSe Layer-3 UE-to-UE Relay shall choose different Source Layer-2 IDs for PC5 links of different types of traffic, i.e., IP traffic, Ethernet traffic and Unstructured traffic. If the PC5 link is used for transferring Unstructured traffic, the 5G ProSe Layer-3 UE-to-UE Relay shall choose different Source Layer-2 IDs for different pair of source and target 5G ProSe Layer-3 End UEs.
6. If the RSC included in the Direct Communication Request matches the target UE's RSC that the target UE is (pre) configured with as specified in clause 5.1.5.1 and if the user info included in the Direct Communication Request matches the target UE's user info, the target 5G ProSe Layer-3 End UE responds by establishing the security with the 5G ProSe Layer-3 UE-to-UE Relay. When the security protection is enabled, the 5G ProSe Layer-3 UE-to-UE Relay sends the parameters as described in clause 6.4.3.7 to the target 5G ProSe Layer-3 End UE.
   The Source Layer-2 ID used for the security establishment procedure is self-assigned by the target 5G ProSe Layer-3 End UE and the Destination Layer-2 ID is set to the Source Layer-2 ID of the received Direct Communication Request message.
   Upon receiving the security establishment procedure messages, the 5G ProSe Layer-3 UE-to-UE Relay obtains the target 5G ProSe Layer-3 End UE's Layer-2 ID for future communication, for signalling and data traffic for this unicast link.
7. The target 5G ProSe Layer-3 End UE sends a Direct Communication Accept message to the 5G ProSe Layer-3 UE-to-UE Relay that has successfully established security with. The parameters included in the Direct Communication Accept message are described in clause 6.4.3.7.
NOTE: The 5G ProSe Layer-3 UE-to-UE Relay can detect that the Ethernet MAC address of target 5G ProSe Layer-3 End UE is already used by another 5G ProSe Layer-3 End UE when it receives the Direct Communication Accept message.
8. For IP traffic, IPv6 prefix or IPv4 address is allocated for the target 5G ProSe Layer-3 End UE as defined in clause 5.5.1.4.
9. After receiving the Direct Communication Accept message from the target 5G ProSe Layer-3 End UE, the 5G ProSe Layer-3 UE-to-UE Relay sends a Direct Communication Accept message to the source 5G ProSe Layer-3 End UE that has successfully established security with. The parameters included in the Direct Communication Accept message are described in clause 6.4.3.7.
10. For IP traffic, IPv6 prefix or IPv4 address is allocated for the source 5G ProSe Layer-3 End UE as defined in clause 5.5.1.4.
11. For IP communication, the 5G ProSe Layer-3 UE-to-UE Relay may store an association of user info (i.e. Application Layer ID) and the IP address of target 5G ProSe Layer-3 End UE into its DNS entries and the 5G ProSe Layer-3 UE-to-UE Relay may act as a DNS server to other UEs. The source 5G ProSe Layer-3 End UE may send a DNS query to the 5G ProSe Layer-3 UE-to-UE Relay to request IP address of target 5G ProSe Layer-3 End UE after step 10 if the IP address of target 5G ProSe Layer-3 End UE is not received in step 9 and the 5G ProSe Layer-3 UE-to-UE Relay returns the IP address of the target 5G ProSe Layer-3 End UE to the source 5G ProSe Layer-3 End UE.
   For Ethernet communication, the 5G ProSe Layer-3 UE-to-UE Relay maintains the association between PC5 links and Ethernet MAC addresses received from the 5G ProSe Layer-3 End UE.
   For Unstructured traffic communication, for each pair of source and target 5G ProSe Layer-3 End UEs, the 5G ProSe Layer-3 UE-to-UE Relay maintains the 1:1 mapping between the PC5 link with source 5G ProSe Layer-3 End UE and the PC5 link with target 5G ProSe Layer-3 End UE.
12. The source 5G ProSe Layer-3 End UE communicates with the target 5G ProSe Layer-3 End UE via the 5G ProSe Layer-3 UE-to-UE Relay.
   In the case of one source 5G ProSe Layer-3 End UE communicates with multiple target 5G ProSe Layer-3 End UEs, the PC5 link between the source 5G ProSe Layer-3 End UE and the 5G ProSe Layer-3 UE-to-UE Relay can be shared for multiple target 5G ProSe Layer-3 End UEs per RSC while the PC5 links may be established individually between the 5G ProSe Layer-3 UE-to-UE Relay and target 5G ProSe Layer-3 End UEs per RSC. For the shared PC5 link, the Layer-2 link modification procedure shall be used, replacing the step 3 to 4 and 9 to 10 of the procedure in FIG. 6.7.1.1-1. The parameters used in the Layer-2 link modification procedure are described in clause 6.4.3.7.
   In the case of multiple source 5G ProSe Layer-3 End UEs communicate with one target 5G ProSe Layer-3 End UE, the PC5 link between the 5G ProSe Layer-3 UE-to-UE Relay and the target 5G ProSe Layer-3 End UE can be shared per RSC while the PC5 links may be established individually between the source 5G ProSe Layer-3 End UEs and the 5G ProSe Layer-3 UE-to-UE Relay per RSC. For the shared PC5 link, the Layer-2 link modification procedure shall be used, replacing the step 5 to 8 of the procedure in FIG. 6.7.1.1-1. The parameters used in the Layer-2 link modification procedure are described in clause 6.4.3.7.
   [ . . . ]
   6.7.3 5G ProSe UE-to-UE Relay Communication with Integrated Discovery

### 6.7.3.1 General

5G ProSe Communication via 5G ProSe UE-to-UE Relay with integrated Discovery is supported. For 5G ProSe UE-to-UE Relay Communication with integrated Discovery, when a UE allows a UE-to-UE relay to be involved in the Direct Communication Request to the other UE, the UE indicates it by including a relay_indication in the broadcasted Direct Communication Request message.
When a UE-to-UE relay receives a Direct Communication Request including a relay_indication, it decides whether to send a Direct Communication Request message including its own User Info according to e.g. Relay Service Code if there is any, ProSe Service Info, operator policy per Relay Service Code, signal strength and local policy.

### 6.7.3.2 Procedure for Communication via Layer-3 UE-to-UE Relay

[FIG. 6.7.3.2-1 of 3GPP TS 23.304 V18.7.0, entitled “5G ProSe UE-to-UE Relay Communication with integrated Discovery via Layer-3 UE-to-UE Relay”, is reproduced as FIG. 6]
0. 5G ProSe End UEs are authorized and provisioned with parameters to use the service provided by the 5G ProSe UE-to-UE Relays. 5G ProSe UE-to-UE Relays are authorized and provisioned with parameters to provide service of relaying traffic among 5G ProSe End UEs.
1. The source 5G ProSe End UE (i.e. UE-1) wants to establish a unicast communication with the target 5G ProSe End UE (i.e. UE-2) and broadcasts a Direct Communication Request. The parameters included in the Direct Communication Request message are described in clause 6.4.3.7.
   The relay_indication in the Direct Communication Request is used to indicate whether 5G ProSe UE-to-UE Relay can forward the Direct Communication Request message (i.e. send a Direct Communication Request based on the received Direct Communication Request message) or not. It is also used to limit the number of hops of 5G ProSe UE-to-UE Relay by removing relay_indication in the Direct Communication Request message from the 5G ProSe UE-to-UE Relay.
   The Source Layer-2 ID and Destination Layer-2 ID used for the Direct Communication Request message are defined in clause 5.8.5.
   The source 5G ProSe End UE gets application information and optional ProSe Application Requirements from ProSe application layer, and determines the end-to-end Qos parameters as described in clause 5.6.3.1.
NOTE 1: The data type of relay_indication can be determined in Stage 3.
2. When receiving Direct Communication Request with relay_indication from UE-1, the 5G ProSe UE-to-UE Relay (i.e. Relay-1 and Relay-2) may decide to participate in the procedure and broadcast a Direct Communication Request message in its proximity without relay_indication. The parameters included in the Direct Communication Request message are described in clause 6.4.3.7.
   The Source Layer-2 ID and Destination Layer-2 ID used for the Direct Communication Request message are defined in clause 5.8.5.
3. When UE-2 receives a Direct Communication Request from one or multiple 5G ProSe UE-to-UE Relays, UE-2 select a 5G ProSe UE-to-UE Relay which UE-2 will respond. UE-2 may select the 5G ProSe UE-to-UE Relay according to e.g. the signal strength, local policy, operator policy per Relay Service Code if any.
4. The security establishment happens between UE-2 and the selected 5G ProSe UE-to-UE Relay (here Relay-1), if needed.
   If the existing PC5 link can be reused, Link Modification Request and Link Modification Accept messages are used.
NOTE 2: The conflict between Link Modification Request and Direct Communication Request can be determined in Stage 3.
5. UE-2 replies Direct Communication Accept message to Relay-1. The parameters included in the Direct Communication Accept message are described in clause 6.4.3.7.
6. For IP traffic, IPV6 prefix or IPv4 address is allocated for the target 5G ProSe Layer-3 End UE as defined in clause 5.5.1.4.
7. Security establishment happens between UE-1 and Relay-1, if needed.
8. For 5G ProSe UE-to-UE Relay Communication with integrated Discovery, after receiving QoS Info of the end-to-end QoS from UE-1, Relay-1 provides the QoS info of the second hop QoS to UE-2 with Link Modification Request message.
9. For 5G ProSe UE-to-UE Relay Communication with integrated Discovery, UE-2 responds with a Link Modification Accept message.
10. Relay-1 responds with Direct Communication Accept to the UE-1. The parameters included in the Direct Communication Accept message are described in clause 6.4.3.7.
11. For IP traffic, IPv6 prefix or IPv4 address is allocated for the source 5G ProSe Layer-3 End UE as defined in clause 5.5.1.4.
12. For IP communication, the 5G ProSe Layer-3 UE-to-UE Relay may store an association of user info (i.e. Application Layer ID) and the IP address of target 5G ProSe Layer-3 End UE into its DNS entries and the 5G ProSe Layer-3 UE-to-UE Relay may act as a DNS server to other UEs. The source 5G ProSe Layer-3 End UE may send a DNS query to the 5G ProSe Layer-3 UE-to-UE Relay to request IP address of target 5G ProSe Layer-3 End UE after step 11 if the IP address of target 5G ProSe Layer-3 End UE is not received in step 10 and the 5G ProSe Layer-3 UE-to-UE Relay returns the IP address of the target 5G ProSe Layer-3 End UE to the source 5G ProSe Layer-3 End UE.
   For Ethernet communication, the 5G ProSe Layer-3 UE-to-UE Relay is acting as an Ethernet switch by maintaining the association between PC5 links and Ethernet MAC addresses received from the 5G ProSe Layer-3 End UE.
   For Unstructured traffic communication, for each pair of source and target 5G ProSe Layer-3 End UEs, the 5G ProSe Layer-3 UE-to-UE Relay maintains the 1:1 mapping between the PC5 link with source 5G ProSe Layer-3 End UE and the PC5 link with target 5G ProSe Layer-3 End UE.
   The source 5G ProSe Layer-3 End UE communicates with the target 5G ProSe Layer-3 End UE via the 5G ProSe Layer-3 UE-to-UE Relay.

3GPP TS 24.554 introduced the following:

### 7.2.2.4 5G ProSe Direct Link Establishment Procedure Completion by the Initiating UE

If the 5G ProSe direct link establishment procedure is not for direct communication between the source 5G ProSe end UE and the 5G ProSe UE-to-UE relay UE, and:
if the Target user info IE is included in the PROSE DIRECT LINK ESTABLISHMENT REQUEST message, upon receipt of the PROSE DIRECT LINK ESTABLISHMENT ACCEPT message, the initiating UE shall stop timer T5080; or
if the Target user info IE is not included in the PROSE DIRECT LINK ESTABLISHMENT REQUEST message, the initiating UE may keep the timer T5080 running and continue to handle multiple response messages (i.e., the PROSE DIRECT LINK ESTABLISHMENT ACCEPT message) from multiple target UEs.
   If the 5G ProSe direct link establishment procedure is for direct communication between the source 5G ProSe end UE and 5G ProSe UE-to-UE relay UE, and:
if the UE-to-UE relay UE user info IE is included in the PROSE DIRECT LINK ESTABLISHMENT REQUEST message, upon receipt of the PROSE DIRECT LINK ESTABLISHMENT ACCEPT message, the initiating UE shall stop timer T5080; or
if the UE-to-UE relay UE user info IE is not included in the PROSE DIRECT LINK ESTABLISHMENT REQUEST message (i.e. the 5G ProSe direct link establishment procedure is for direct communication between the source 5G ProSe end UE and 5G ProSe UE-to-UE relay UE with integrated discovery), the initiating UE may keep the timer T5080 running and continue to handle multiple response messages (i.e., the PROSE DIRECT LINK ESTABLISHMENT ACCEPT message) from multiple target UEs.
   For each of the PROSE DIRECT LINK ESTABLISHMENT ACCEPT message received, the initiating UE shall uniquely assign a PC5 link identifier and create a 5G ProSe direct link context for each of the 5G ProSe direct link(s). Then the initiating UE shall store the source layer-2 ID and the destination layer-2 ID used in the transport of this message provided by the lower layers in the 5G ProSe direct link context(s) to complete the establishment of the 5G ProSe direct link with the target UE(s). From this time onward the initiating UE shall use the established link(s) for ProSe direct communication over PC5 and additional PC5 signalling messages to the target UE(s).
   If the initiating UE is acting as the 5G ProSe UE-to-UE relay UE and the 5G ProSe direct link establishment procedure is for direct communication between the 5G ProSe UE-to-UE relay UE and target 5G ProSe end UE with integrated discovery, the initiating UE upon receipt of the PROSE DIRECT LINK ESTABLISHMENT ACCEPT message from the target 5G ProSe end UE, shall initiate the 5G ProSe direct link security mode control procedure with the source 5G ProSe end UE, and the initiating UE upon successful completion of the 5G ProSe direct link security mode control procedure with the source 5G ProSe end UE, shall create a PROSE DIRECT LINK ESTABLISHMENT ACCEPT message as specified in clause 7.2.2.3 to send to the source 5G ProSe end UE. If the target user info IE is not included in the PROSE DIRECT LINK ESTABLISHMENT REQUEST message, the initiating UE acting as the 5G ProSe UE-to-UE relay UE may initiate the 5G ProSe direct link security mode control procedure with the source 5G ProSe end UE after handling multiple response messages (i.e., the PROSE DIRECT LINK ESTABLISHMENT ACCEPT message) from multiple target end UEs. If the target user info IE is not included in the PROSE DIRECT LINK ESTABLISHMENT REQUEST message, the initiating UE acting as the 5G ProSe UE-to-UE relay UE may initiate the 5G ProSe direct link modification procedure to add additional target 5G ProSe end UE to the source 5G ProSe end UE after handling multiple response messages (i.e., the PROSE DIRECT LINK ESTABLISHMENT ACCEPT message) from multiple target end UEs.
   After receiving the PROSE DIRECT LINK ESTABLISHMENT ACCEPT message, the initiating UE shall provide the following information along with the layer-2 IDs to the lower layer, which enables the lower layer to handle the coming PC5 signalling or traffic data:
a) the PC5 link identifier self-assigned for this 5G ProSe direct link;
b) PQFI(s) and its corresponding PC5 QoS parameters, if available; and
c) an indication of activation of the PC5 unicast user plane security protection for the 5G ProSe direct link, if applicable.
   The initiating UE shall start timer T5090 if:
a) at least one of ProSe identifiers for the 5G ProSe direct links satisfies the privacy requirements as specified in clause 5.2.4; or
b) T5090 is configured as specified in clause 5.2.5.
   In addition, the initiating UE may perform the PC5 QoS flow establishment over 5G ProSe direct link as specified in clause 7.2.7.
   Upon expiry of the timer T5080, if:
the 5G ProSe direct link establishment procedure is not for direct communication between the source 5G ProSe end UE and the 5G ProSe UE-to-UE relay UE, and the PROSE DIRECT LINK ESTABLISHMENT REQUEST message did not include the Target user info IE; or
the 5G ProSe direct link establishment procedure is for direct communication between the source 5G ProSe end UE and the 5G ProSe UE-to-UE relay UE, and the PROSE DIRECT LINK ESTABLISHMENT REQUEST message did not include the UE-to-UE relay UE user info IE;
   and the initiating UE received at least one PROSE DIRECT LINK ESTABLISHMENT ACCEPT message, it is up to the UE implementation to consider the 5G ProSe direct link establishment procedure as complete or to restart the timer T5080.

If the 5G ProSe direct link establishment procedure is triggered by a PROSE DIRECT LINK MODIFICATION REQUEST message from the source 5G ProSe layer-3 end UE as specified in clause 7.2.3.2, upon receipt of the PROSE DIRECT LINK ESTABLISHMENT ACCEPT message, the initiating UE shall send a PROSE DIRECT LINK MODIFICATION ACCEPT message to the source 5G ProSe layer-3 end UE as specified in clause 7.2.3.3, if the initiating UE acts as the 5G ProSe layer-3 UE-to-UE relay UE.

If the 5G ProSe direct link establishment procedure is for 5G ProSe direct communication between the 5G ProSe layer-3 UE-to-UE relay UE and the target 5G ProSe layer-3 end UE, for Ethernet traffic, and the initiating UE acting as the 5G ProSe layer-3 UE-to-UE relay UE detects that the MAC address of the target 5G ProSe layer-3 end UE in the PROSE DIRECT LINK ESTABLISHMENT ACCEPT message is not unique, i.e., the MAC address of the target 5G ProSe layer-3 end UE was also provided by another 5G ProSe layer-3 end UE in an existing ProSe 5G direct link, the 5G ProSe layer-3 UE-to-UE relay UE shall perform 5G ProSe direct link release procedure as specified in clause 7.2.6.

### 7.2.2.5 5G ProSe Direct Link Establishment Procedure not Accepted by the Target UE

If the PROSE DIRECT LINK ESTABLISHMENT REQUEST message cannot be accepted, the target UE shall send a PROSE DIRECT LINK ESTABLISHMENT REJECT message. The PROSE DIRECT LINK ESTABLISHMENT REJECT message contains a PC5 signalling protocol cause IE set to one of the following cause values:
#1 direct communication to the target UE not allowed;
#3 conflict of layer-2 ID for unicast communication is detected;
#5 lack of resources for 5G ProSe direct link;
#13 congestion situation;
#15 security procedure failure of 5G ProSe UE-to-network relay;
#22 security procedure failure of 5G ProSe UE-to-UE relay;
#20 Failure from 5G ProSe end UE;
#21 5G ProSe direct link already exists;
#23 MAC address not unique;
#25 triggering security procedure not possible; or
#111 protocol error, unspecified.
   [ . . . ]
   If the 5G ProSe direct link establishment procedure is for 5G ProSe direct communication between the source 5G ProSe layer-3 end UE and the 5G ProSe layer-3 UE-to-UE relay UE, for Ethernet traffic, and the target UE acting as the 5G ProSe layer-3 UE-to-UE relay UE detects that the MAC address of the source 5G ProSe layer-3 end UE in the PROSE DIRECT LINK SECURITY MODE COMPLETE message is not unique, i.e., the MAC address of the source 5G ProSe layer-3 end UE was also provided by another 5G ProSe layer-3 end UE in an existing ProSe 5G direct link, the 5G ProSe layer-3 UE-to-UE relay UE shall send a PROSE DIRECT LINK ESTABLISHMENT REJECT message containing PC5 signalling protocol cause value #23 “MAC address not unique” to the source 5G ProSe layer-3 end UE.
   If the 5G ProSe direct link establishment procedure is for 5G ProSe direct communication between the source 5G ProSe layer-3 end UE and the 5G ProSe layer-3 UE-to-UE relay UE, for Ethernet traffic, and the target UE acting as the 5G ProSe layer-3 UE-to-UE relay UE releases the 5G ProSe direct link between the 5G ProSe layer-3 UE-to-UE relay UE and the target 5G ProSe layer-3 end UE with PC5 signalling protocol cause value #23 “MAC address not unique”, the 5G ProSe layer-3 UE-to-UE relay UE shall send a PROSE DIRECT LINK ESTABLISHMENT REJECT message containing PC5 signalling protocol cause value #111 “protocol error, unspecified” to the source 5G ProSe layer-3 end UE.
   [ . . . ]

### 7.2.3 5G ProSe Direct Link Modification Procedure

### 7.2.3.1 General

The purpose of the 5G ProSe direct link modification procedure is to modify the existing ProSe direct link to:
a) add new PC5 QoS flow(s) to the existing 5G ProSe direct link;
b) modify existing PC5 QoS flow(s) for updating PC5 QoS parameters of the existing PC5 Qos flow(s);
c) modify existing PC5 QoS flow(s) for associating new ProSe application(s) with the existing PC5 QoS flow(s);
d) modify existing PC5 QoS flow(s) for removing the associated ProSe application(s) from the existing PC5 QoS flow(s);
e) remove existing PC5 QoS flow(s) from the existing 5G ProSe direct link;
f) negotiate a new 5G ProSe UE-to-UE relay UE over the existing 5G ProSe direct link;
g) establish 5G ProSe UE-to-UE relay communication with additional 5G ProSe layer-3 end UE(s) using the existing 5G ProSe direct link between the 5G ProSe layer-3 end UE and 5G ProSe layer-3 UE-to-UE relay UE;
h) release 5G ProSe UE-to-UE relay communication with one of the peer 5G ProSe layer-3 end UEs using the shared 5G ProSe direct link between the 5G ProSe layer-3 end UE and 5G ProSe layer-3 UE-to-UE relay UE;
i) establish 5G ProSe UE-to-UE relay communication with additional 5G ProSe layer-2 end UE(s) using the existing 5G ProSe direct link between the 5G ProSe layer-2 end UE and 5G ProSe layer-2 UE-to-UE relay UE; or
j) for 5G ProSe layer-2 UE-to-UE relay, remove existing PC5 QoS flow(s) from the existing 5G ProSe direct link between the 5G ProSe layer-2 end UE and the 5G ProSe layer-2 UE-to-UE relay UE, when the end-to-end 5G ProSe direct link is released.
   In this procedure, the UE sending the PROSE DIRECT LINK MODIFICATION REQUEST message is called the “initiating UE” and the other UE is called the “target UE”.
NOTE: The 5G ProSe direct link modification procedure is not applicable for 5G ProSe layer-2 UE-to-network relay case.

### 7.2.3.2 5G ProSe Direct Link Modification Procedure Initiated by Initiating UE

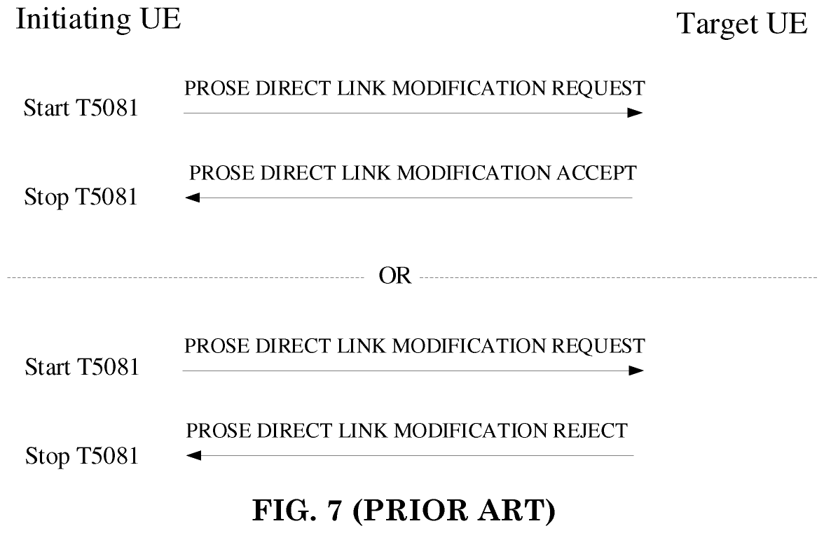

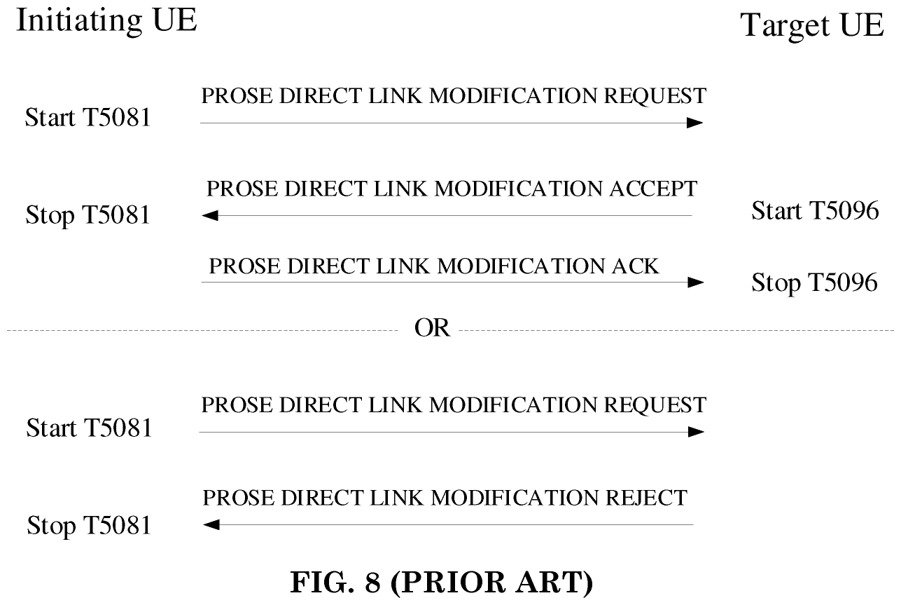

The initiating UE shall meet the following pre-conditions before initiating this procedure for adding a new ProSe application to the existing 5G ProSe direct link:
a) there is a 5G ProSe direct link between the initiating UE and the target UE;
b) the pair of application layer IDs and the network layer protocol of this 5G ProSe direct link are identical to those required by the application layer in the initiating UE for this ProSe application, if the initiating UE is not acting as a 5G ProSe UE-to-network relay UE or 5G ProSe UE-to-UE relay UE for the existing 5G ProSe direct link;
c) the security policy corresponding to the ProSe identifier is aligned with the security policy of the existing 5G ProSe direct link;
d) the timer T5091 is not running; and
e) the initiating UE is not performing the 5G ProSe direct link re-keying procedure initiated by the target UE.
   The initiating UE shall meet the following pre-conditions before initiating this procedure for negotiating a new 5G ProSe UE-to-UE relay UE over the existing 5G ProSe direct link:
a) there is a 5G ProSe direct link between the initiating UE and the target UE;
b) the initiating UE is a source 5G ProSe end UE communicating with the target 5G ProSe end UE via a 5G ProSe UE-to-UE relay UE;
c) the initiating UE determines, e.g., based on PC5 signal strength, to perform UE-to-UE relay reselection; and
d) the initiating UE obtains a list of candidate UE-to-UE relays via UE-to-UE discovery procedure.
   The initiating UE shall meet the following pre-conditions before initiating this procedure for establishing 5G ProSe UE-to-UE relay communication with an additional 5G ProSe layer-3 end UE over the existing 5G ProSe direct link:
a) there is a 5G ProSe direct link between the initiating UE and the target UE;
b) the initiating UE acts as a 5G ProSe layer-3 end UE and the target UE acts as a 5G ProSe layer-3 UE-to-UE relay UE, or vice versa;
c) the initiating UE, if acting as a 5G ProSe layer-3 end UE, determines to communicate with an additional 5G ProSe layer-3 end UE using the same RSC as that of the existing 5G ProSe direct link; and
d) the initiating UE, if acting as a 5G ProSe layer-3 UE-to-UE relay UE, receives a request from another 5G ProSe layer-3 end UE to communicate with the target UE using the same RSC as that of the existing 5G ProSe direct link.
   If the initiating UE is not acting as a 5G ProSe UE-to-network relay UE or 5G ProSe UE-to-UE relay UE for the existing 5G ProSe direct link, after receiving the service data or request from the upper layers, the initiating UE shall perform the PC5 QoS flow match as specified in clause 7.2.8. If there is no matched PC5 QoS flow, the initiating UE shall derive the PC5 Qos parameters and assign the PQFI(s) for the PC5 QoS flows(s) to be established as specified in clause 7.2.7.
   If the 5G ProSe direct link modification procedure is to add new PC5 QoS flow(s) to the existing 5G ProSe direct link, the initiating UE shall create a PROSE DIRECT LINK MODIFICATION REQUEST message. In this message, initiating UE:
a) shall include the PQFI(s), the corresponding PC5 QoS parameters and optionally the ProSe identifier(s);
b) shall include the link modification operation code set to “Add new PC5 QoS flow(s) to the existing 5G ProSe direct link”;
c) may include the PC5 QoS rule(s) to indicate the packet filters of the PC5 QoS flow(s);
d) shall include the source end UE info set to the user info of the source 5G ProSe layer-3 end UE, if the UE acts as a 5G ProSe layer-3 UE-to-UE relay UE, the 5G ProSe direct link is between the 5G ProSe layer-3 UE-to-UE relay UE and the target 5G ProSe layer-3 end UE, and multiple source 5G ProSe layer-3 end UEs have established direct communication with the target 5G ProSe layer-3 end UE via the 5G ProSe layer-3 UE-to-UE relay UE using the same 5G ProSe direct link;
e) may include the source end UE info set to the user info of the source 5G ProSe end UE, if the UE acts as a 5G ProSe UE-to-UE relay UE, the 5G ProSe direct link is between the 5G ProSe UE-to-UE relay UE and the target 5G ProSe end UE, and only one source 5G ProSe end UE has established direct communication with the target 5G ProSe end UE via the 5G ProSe UE-to-UE relay UE using the 5G ProSe direct link;
f) shall include the target end UE info set to the user info of the target 5G ProSe layer-3 end UE, if the UE acts as a source 5G ProSe layer-3 end UE, the 5G ProSe direct link is between the source 5G ProSe layer-3 end UE and the 5G ProSe layer-3 UE-to-UE relay UE, and the source 5G ProSe layer-3 end UE has established direct communication with multiple target 5G ProSe layer-3 end UEs via the 5G ProSe layer-3 UE-to-UE relay UE using the same 5G ProSe direct link;
g) may include the target end UE info set to the user info of the target 5G ProSe end UE, if:
   1) the UE acts as a source 5G ProSe end UE, the 5G ProSe direct link is between the source 5G ProSe end UE and the 5G ProSe UE-to-UE relay UE, and the source 5G ProSe end UE has established direct communication with only one target 5G ProSe end UE via the 5G ProSe UE-to-UE relay UE using the 5G ProSe direct link; or
   2) the UE acts as a 5G ProSe UE-to-UE relay UE and the 5G ProSe direct link is between the 5G ProSe UE-to-UE relay UE and the target 5G ProSe end UE; and
h) may include the target end UE layer-2 ID set to the layer-2 ID of the target 5G ProSe end UE, if the UE acts as a source 5G ProSe end UE and the 5G ProSe direct link is between the source 5G ProSe end UE and the 5G ProSe UE-to-UE relay UE.
   If the 5G ProSe direct link modification procedure is to modify the PC5 QoS parameters for existing PC5 QoS flow(s) in the existing 5G ProSe direct link, the initiating UE shall create a PROSE DIRECT LINK MODIFICATION REQUEST message. In this message, the initiating UE:
a) shall include the PQFI(s) and the corresponding PC5 QoS parameters, including the ProSe identifier(s);
b) shall include the link modification operation code set to “Modify PC5 QoS parameters of the existing PC5 QoS flow(s)”;
c) may include the PC5 QoS rule(s) to indicate the packet filters of the PC5 QoS flow(s);
d) shall include the source end UE info set to the user info of the source 5G ProSe layer-3 end UE, if the UE acts as a 5G ProSe layer-3 UE-to-UE relay UE, the 5G ProSe direct link is between the 5G ProSe layer-3 UE-to-UE relay UE and the target 5G ProSe layer-3 end UE, and multiple source 5G ProSe layer-3 end UEs have established direct communication with the target 5G ProSe layer-3 end UE via the 5G ProSe layer-3 UE-to-UE relay UE using the same 5G ProSe direct link;
e) may include the source end UE info set to the user info of the source 5G ProSe end UE, if the UE acts as a 5G ProSe UE-to-UE relay UE, the 5G ProSe direct link is between the 5G ProSe UE-to-UE relay UE and the target 5G ProSe end UE, and only one source 5G ProSe end UE has established direct communication with the target 5G ProSe end UE via the 5G ProSe UE-to-UE relay UE using the 5G ProSe direct link;
f) shall include the target end UE info set to the user info of the target 5G ProSe layer-3 end UE, if the UE acts as a source 5G ProSe layer-3 end UE, the 5G ProSe direct link is between the source 5G ProSe layer-3 end UE and the 5G ProSe layer-3 UE-to-UE relay UE, and the source 5G ProSe layer-3 end UE has established direct communication with multiple target 5G ProSe layer-3 end UEs via the 5G ProSe layer-3 UE-to-UE relay UE using the same 5G ProSe direct link;
g) may include the target end UE info set to the user info of the target 5G ProSe end UE, if:
   1) the UE acts as a source 5G ProSe end UE, the 5G ProSe direct link is between the source 5G ProSe end UE and the 5G ProSe UE-to-UE relay UE, and the source 5G ProSe end UE has established direct communication with only one target 5G ProSe end UE via the 5G ProSe UE-to-UE relay UE using the 5G ProSe direct link; or
   2) the UE acts as a 5G ProSe UE-to-UE relay UE and the 5G ProSe direct link is between the 5G ProSe UE-to-UE relay UE and the target 5G ProSe end UE; and
h) may include the target end UE layer-2 ID set to the destination layer-2 ID of the target 5G ProSe end UE, if the UE acts as a source 5G ProSe end UE and the 5G ProSe direct link is between the source 5G ProSe end UE and the 5G ProSe UE-to-UE relay UE.
   If the 5G ProSe direct link modification procedure is to associate new ProSe application(s) with existing PC5 QoS flow(s), the initiating UE shall create a PROSE DIRECT LINK MODIFICATION REQUEST message. In this message, the initiating UE:
a) shall include the PQFI(s) and the corresponding PC5 QoS parameters, including the ProSe identifier(s);
b) shall include the link modification operation code set to “Associate new ProSe application(s) with existing PC5 QoS flow(s)”;
c) may include the PC5 QoS rule(s) to indicate the packet filters of the PC5 QoS flow(s);
d) shall include the source end UE info set to the user info of the source 5G ProSe layer-3 end UE, if the UE acts as a 5G ProSe layer-3 UE-to-UE relay UE, the 5G ProSe direct link is between the 5G ProSe layer-3 UE-to-UE relay UE and the target 5G ProSe layer-3 end UE, and multiple source 5G ProSe layer-3 end UEs have established direct communication with the target 5G ProSe layer-3 end UE via the 5G ProSe layer-3 UE-to-UE relay UE using the same 5G ProSe direct link;
e) may include the source end UE info set to the user info of the source 5G ProSe end UE, if the UE acts as a 5G ProSe UE-to-UE relay UE, the 5G ProSe direct link is between the 5G ProSe UE-to-UE relay UE and the target 5G ProSe end UE, and only one source 5G ProSe end UE has established direct communication with the target 5G ProSe end UE via the 5G ProSe UE-to-UE relay UE using the 5G ProSe direct link;
f) shall include the target end UE info set to the user info of the target 5G ProSe layer-3 end UE, if the UE acts as a source 5G ProSe layer-3 end UE, the 5G ProSe direct link is between the source 5G ProSe layer-3 end UE and the 5G ProSe layer-3 UE-to-UE relay UE, and the source 5G ProSe layer-3 end UE has established direct communication with multiple target 5G ProSe layer-3 end UEs via the 5G ProSe layer-3 UE-to-UE relay UE using the same 5G ProSe direct link;
g) may include the target end UE info set to the user info of the target 5G ProSe end UE, if:
   1) the UE acts as a source 5G ProSe end UE, the 5G ProSe direct link is between the source 5G ProSe end UE and the 5G ProSe UE-to-UE relay UE, and the source 5G ProSe end UE has established direct communication with only one target 5G ProSe end UE via the 5G ProSe UE-to-UE relay UE using the 5G ProSe direct link; or
   2) the UE acts as a 5G ProSe UE-to-UE relay UE and the 5G ProSe direct link is between the 5G ProSe UE-to-UE relay UE and the target 5G ProSe end UE; and
h) may include the target end UE layer-2 ID set to the layer-2 ID of the target 5G ProSe end UE, if the UE acts as a source 5G ProSe end UE and the 5G ProSe direct link is between the source 5G ProSe end UE and the 5G ProSe UE-to-UE relay UE.
   If the PC5 5G ProSe direct link modification procedure is to remove the associated ProSe application(s) from existing PC5 QoS flow(s), the initiating UE shall create a PROSE DIRECT LINK MODIFICATION REQUEST message. In this message, the initiating UE:
a) shall include the PQFI(s) and the corresponding PC5 QoS parameters including the ProSe identifier(s); and
b) shall include the link modification operation code set to “Remove ProSe application(s) from existing PC5 QoS flow(s)”.
   If the direct link modification procedure is to remove any PC5 QoS flow(s) from the existing 5G ProSe direct link, the initiating UE shall create a PROSE DIRECT LINK MODIFICATION REQUEST message. In this message, the initiating UE:
a) shall include the PQFI(s); and
b) shall include the link modification operation code set to “Remove existing PC5 QoS flow(s) from the existing 5G ProSe direct link”.
   If the 5G ProSe direct link modification procedure is to establish 5G ProSe UE-to-UE relay communication with additional 5G ProSe layer-3 end UE using the existing 5G ProSe direct link between the 5G ProSe layer-3 end UE and 5G ProSe layer-3 UE-to-UE relay UE, the initiating UE shall create a PROSE DIRECT LINK MODIFICATION REQUEST message. In this message, the initiating UE:
a) shall include the source end UE info set to the user info of the source 5G ProSe layer-3 end UE and the target end UE info set to the user info of the target 5G ProSe layer-3 end UE received in PROSE DIRECT LINK ESTABLISHMENT REQUEST message, if the UE acts as a 5G ProSe layer-3 UE-to-UE relay UE and the 5G ProSe direct link is between the 5G ProSe layer-3 UE-to-UE relay UE and the target 5G ProSe layer-3 end UE;
b) for Ethernet traffic, shall include the MAC address of the source 5G ProSe layer-3 end UE, if the UE acts as a 5G ProSe layer-3 UE-to-UE relay UE and the 5G ProSe direct link is between the 5G ProSe layer-3 UE-to-UE relay UE and the target 5G ProSe layer-3 end UE and shall include the MAC address of the source 5G ProSe layer-3 end UE, if:
   1) the UE acts as a source 5G ProSe layer-3 UE-to-UE end UE;
   2) the MAC address of the source 5G ProSe layer-3 end UE changed; and
   3) the 5G ProSe direct link is between the 5G ProSe layer-3 UE-to-UE relay UE and the source 5G ProSe layer-3 end UE;
c) shall include the target end UE info set to the user info of the additional target 5G ProSe layer-3 end UE to which the 5G ProSe UE-to-UE relay communication is requested, if the UE acts as a source 5G ProSe layer-3 end UE or a 5G ProSe layer-3 UE-to-UE relay UE, and the 5G ProSe direct link is between the source 5G ProSe layer-3 end UE and the 5G ProSe layer-3 UE-to-UE relay UE;
d) shall include the link modification operation code set to “Add new 5G ProSe layer-3 end UE to the existing 5G ProSe direct link”;
e) may include the PQFI(s) and the corresponding PC5 QoS parameters including the ProSe identifier(s);
f) may include the PC5 QoS rule(s) to indicate the packet filters of the PC5 QoS flow(s); and
g) may include the target end UE layer-2 ID set to the layer-2 ID of the target 5G ProSe layer-3 end UE, if the UE acts as a source 5G ProSe layer-3 end UE and the 5G ProSe direct link is between the source 5G ProSe layer-3 end UE and the 5G ProSe layer-3 UE-to-UE relay UE.
   If the 5G ProSe direct link modification procedure is to establish 5G ProSe UE-to-UE relay communication with additional 5G ProSe layer-2 end UE using the existing 5G ProSe direct link between the 5G ProSe layer-2 end UE and 5G ProSe layer-2 UE-to-UE relay UE, the initiating UE shall create a PROSE DIRECT LINK MODIFICATION REQUEST message. In this message, the initiating UE:
a) shall include the source end UE info set to the user info of the source 5G ProSe layer-2 end UE and the target end UE info set to the user info of the target 5G ProSe layer-2 end UE received in PROSE DIRECT LINK ESTABLISHMENT REQUEST message, if the UE acts as a 5G ProSe layer-2 UE-to-UE relay UE and the 5G ProSe direct link is between the 5G ProSe layer-2 UE-to-UE relay UE and the target 5G ProSe layer-2 end UE;
b) shall include the target end UE info set to the user info of the additional target 5G ProSe layer-2 end UE to which the 5G ProSe UE-to-UE relay communication is requested, if the UE acts as a source 5G ProSe layer-2 end UE and the 5G ProSe direct link is between the source 5G ProSe layer-2 end UE and the 5G ProSe layer-2 UE-to-UE relay UE; and
c) shall include the link modification operation code set to “Add new 5G ProSe layer-2 end UE to the existing 5G ProSe direct link”.
   The initiating UE, if acting as the source 5G ProSe end UE, shall meet the following pre-conditions before initiating this procedure for establishing 5G ProSe UE-to-UE relay communication with additional 5G ProSe end UE via the same 5G ProSe layer-2 UE-to-UE relay UE:
a) there is no ongoing 5G ProSe direct link establishment or modification procedure between the initiating UE and the 5G ProSe layer-2 UE-to-UE relay UE for establishing 5G ProSe UE-to-UE relay communication with a target 5G ProSe end UE.
NOTE: The source 5G ProSe end UE does not initiate any 5G ProSe direct link modification procedure towards the same 5G ProSe layer-2 UE-to-UE relay UE for communication with a different target 5G ProSe layer-2 end UE, unless any current 5G ProSe direct link establishment or 5G ProSe direct link modification procedure has been completed including reception of the layer-2 ID of the target 5G ProSe end UE from the 5G ProSe layer-2 UE-to-UE relay UE as specified in TS 38.300 [12].
   If the 5G ProSe direct link modification procedure is to release 5G ProSe UE-to-UE relay communication with one of the peer 5G ProSe layer-3 end UEs using the shared 5G ProSe direct link between the 5G ProSe layer-3 end UE and 5G ProSe layer-3 UE-to-UE relay UE, the initiating UE shall create a PROSE DIRECT LINK MODIFICATION REQUEST message. In this message, initiating UE:
a) shall include the source end UE info set to the source user info of the 5G ProSe layer-3 end UE received in the PROSE DIRECT LINK RELEASE REQUEST message, if the UE acts as a 5G ProSe layer-3 UE-to-UE relay UE and the 5G ProSe direct link is between the 5G ProSe layer-3 UE-to-UE relay UE and the 5G ProSe layer-3 end UE;
b) shall include the target end UE info set to the user info of the peer 5G ProSe layer-3 end UE with which the 5G ProSe UE-to-UE relay communication is to be released, if the UE acts as a 5G ProSe layer-3 end UE and the 5G ProSe direct link is between the 5G ProSe layer-3 end UE and the 5G ProSe layer-3 UE-to-UE relay UE; and
c) shall include the link modification operation code set to “Remove 5G ProSe layer-3 end UE from the existing 5G ProSe direct link”.
   If the 5G ProSe direct link modification procedure is to trigger the negotiated 5G ProSe layer-3 UE-to-UE relay reselection, the initiating UE shall create a PROSE DIRECT LINK MODIFICATION REQUEST message. In this message:
a) If the initiating UE acts as a source 5G ProSe layer-3 end UE and the 5G ProSe direct link is between the source 5G ProSe layer-3 end UE and the 5G ProSe layer-3 UE-to-UE relay UE, the initiating UE:
   1) shall include the relay reselection indication;
   2) shall include the list of user info IDs of the candidates 5G ProSe UE-to-UE relay UEs supporting the same RSC used for the existing 5G ProSe direct link;
   3) shall include the list of target 5G ProSe end UEs IP address/prefix, if IP communication is used; and
   4) may include the list of layer-2 IDs of the candidates 5G ProSe UE-to-UE relay UEs supporting the same RSC used for the existing 5G ProSe direct link; or
b) If the initiating UE acts as a 5G ProSe layer-3 UE-to-UE relay UE and the 5G ProSe direct link is between the 5G ProSe layer-3 UE-to-UE relay UE and the target 5G ProSe end UE, the initiating UE:
   1) shall include the relay reselection indication;
   2) shall include the list of user info IDs of the candidates 5G ProSe UE-to-UE relay UEs supporting the same RSC used for the existing 5G ProSe direct link;
   3) shall include the initiating source 5G ProSe UE IP address/prefix, if IP communication is used; and
   4) may include list of layer-2 IDs of the candidates 5G ProSe UE-to-UE relay UEs supporting the same RSC used for the existing 5G ProSe direct link.
      If the 5G ProSe direct link modification procedure is to trigger the negotiated 5G ProSe layer-3 UE-to-UE relay reselection and the initiating UE acts as a 5G ProSe layer-3 UE-to-UE relay UE, the initiating UE shall create a PROSE DIRECT LINK MODIFICATION REQUEST message for every IP address/prefix of the target 5G ProSe layer-3 end UEs received on the associated PROSE DIRECT LINK MODIFICATION REQUEST message from the source 5G ProSe layer-3 end UE.
      If the 5G ProSe direct link modification procedure is to trigger the negotiated 5G ProSe layer-2 UE-to-UE relay reselection, the initiating UE shall create a PROSE DIRECT LINK MODIFICATION REQUEST message. In this message:
a) shall include the relay reselection indication;
b) shall include the list of candidates 5G ProSe UE-to-UE relay UE user info ID;
c) shall include the new MSBs of K_{NRP} ID; and
d) may include the list of candidates 5G ProSe UE-to-UE relay UE layer-2 ID.
   If the 5G ProSe direct link modification procedure is to trigger the negotiated 5G ProSe UE-to-UE relay reselection, the initiating UE shall include the link modification operation code IE set to a value other than the reserved value as specified in clause 11.3.19 in the PROSE DIRECT LINK MODIFICATION REQUEST message.
   After the PROSE DIRECT LINK MODIFICATION REQUEST message is generated, the initiating UE shall pass this message to the lower layers for transmission along with the initiating UE's layer-2 ID for 5G ProSe direct communication and the target UE's layer-2 ID for 5G ProSe direct communication and start timer T5081. The UE shall not send a new PROSE DIRECT LINK MODIFICATION REQUEST message to the same target UE while timer T5081 is running.
   [FIG. 7.2.3.2.1 of 3GPP TS 24.554 V18.8.0, entitled “5G ProSe direct link modification procedure”, is reproduced as FIG. 7]
   [FIG. 7.2.3.2.2 of 3GPP TS 24.554 V18.8.0, entitled “5G ProSe direct link modification procedure for the negotiated 5G ProSe layer-3 UE-to-UE relay reselection”, is reproduced as FIG. 8]
   7.2.3.3 5G ProSe direct link modification procedure accepted by the target UE
   If the PROSE DIRECT LINK MODIFICATION REQUEST message is accepted, the target UE shall respond with the PROSE DIRECT LINK MODIFICATION ACCEPT message.
   If the PROSE DIRECT LINK MODIFICATION REQUEST message is to add a new ProSe application, add new PC5 QoS flow(s) or modify any existing PC5 QoS flow(s) in the 5G ProSe direct link, the target UE:
a) shall include the PQFI(s), the corresponding PC5 QoS parameters and optionally the ProSe identifier(s) that the target UE accepts;
b) may include the PC5 QoS rule(s) to indicate the packet filters of the PC5 QoS flow(s);
c) shall include the source end UE info set to the user info of the source 5G ProSe layer-3 end UE, if the UE acts as a target 5G ProSe layer-3 end UE, the 5G ProSe direct link is between the 5G ProSe layer-3 UE-to-UE relay UE and the target 5G ProSe layer-3 end UE, and the target 5G ProSe layer-3 end UE has established direct communication with multiple source 5G ProSe layer-3 end UEs via the 5G ProSe layer-3 UE-to-UE relay UE using the same 5G ProSe direct link;
d) may include the source end UE info set to the user info of the source 5G ProSe end UE, if the UE acts as a target 5G ProSe end UE, the 5G ProSe direct link is between the 5G ProSe UE-to-UE relay UE and the target 5G ProSe end UE, and the target 5G ProSe end UE has established direct communication with only one source 5G ProSe end UEs via the 5G ProSe UE-to-UE relay UE using the 5G ProSe direct link;
e) shall include the target end UE info set to the user info of the target 5G ProSe end UE, if the UE acts as a 5G ProSe UE-to-UE relay UE and, the 5G ProSe direct link is between the source 5G ProSe end UE and the 5G ProSe UE-to-UE relay UE, and the source 5G ProSe layer-3 end UE has established direct communication with multiple target 5G ProSe layer-3 end UEs via the 5G ProSe layer-3 UE-to-UE relay UE using the same 5G ProSe direct link; and
f) may include the target end UE info set to the user info of the target 5G ProSe end UE, if the UE acts as a 5G ProSe UE-to-UE relay UE, the 5G ProSe direct link is between the source 5G ProSe end UE and the 5G ProSe UE-to-UE relay UE, and the source 5G ProSe end UE has established direct communication with only one target 5G ProSe end UE via the 5G ProSe UE-to-UE relay UE using the 5G ProSe direct link;
   in the PROSE DIRECT LINK MODIFICATION ACCEPT message.
   If the PROSE DIRECT LINK MODIFICATION REQUEST message is to remove an existing ProSe application from the 5G ProSe direct link, the target UE shall delete the ProSe identifier received in the PROSE DIRECT LINK MODIFICATION REQUEST message and the corresponding PQFI(s) and PC5 QoS parameters from the profile associated with the 5G ProSe direct link.
   If the PROSE DIRECT LINK MODIFICATION REQUEST message is to remove existing PC5 QoS flow(s) from the PC5 5G ProSe direct link, the target UE shall delete the PQFI(s) and the corresponding PC5 QoS parameters from the profile associated with the 5G ProSe direct link. If the PROSE DIRECT LINK MODIFICATION REQUEST message is to add a new ProSe application, add new PC5 QoS flow(s) or modify any existing PC5 QoS flow(s) in the 5G ProSe direct link, after sending the PROSE DIRECT LINK MODIFICATION ACCEPT message, the target UE shall provide the added or modified PQFI(s) and corresponding PC5 QoS parameters along with PC5 link identifier to the lower layer.
   If the PROSE DIRECT LINK MODIFICATION REQUEST message is to remove an existing ProSe application or to remove the existing PC5 QoS flow(s) from the 5G ProSe direct link, after sending the PROSE DIRECT LINK MODIFICATION ACCEPT message, the target UE shall provide the removed PQFI(s) along with the PC5 link identifier to the lower layer.
   If the PROSE DIRECT LINK MODIFICATION REQUEST message is to establish 5G ProSe UE-to-UE relay communication with additional 5G ProSe layer-3 end UE using the existing 5G ProSe direct link between the 5G ProSe layer-3 end UE and 5G ProSe layer-3 UE-to-UE relay UE, the target UE:
a) if acting as the 5G ProSe layer-3 UE-to-UE relay UE, shall perform the 5G ProSe direct link establishment procedure towards the target 5G ProSe layer-3 end UE as specified in clause 7.2.2.2; and after receiving the PROSE DIRECT LINK ESTABLISHMENT ACCEPT message from the target 5G ProSe layer-3 end UE, shall create a PROSE DIRECT LINK MODIFICATION ACCEPT message;
b) if acting as the target 5G ProSe layer-3 end UE, shall create a PROSE DIRECT LINK MODIFICATION ACCEPT message; and
c) in the PROSE DIRECT LINK MODIFICATION ACCEPT message, the target UE:
   1) if the UE acts as the target 5G ProSe layer-3 end UE:
      i) shall include the source end UE info set to the user info of the source 5G ProSe layer-3 end UE and the target end UE info set to the user info of the target 5G ProSe layer-3 end UE; and
      ii) for Ethernet traffic, shall include the MAC address of the target 5G ProSe layer-3 end UE if the MAC address of the target 5G ProSe layer-3 end UE changed;
   2) if the UE acts as the 5G ProSe layer-3 UE-to-UE relay UE:
      i) shall include the target end UE info set to the user info of the target 5G ProSe layer-3 end UE;
      ii) for IP traffic, may include the target 5G ProSe layer-3 end UE IP address IE set to the IP address of the additional target 5G ProSe layer-3 end UE; and
      iii) for Ethernet traffic, shall include the MAC address of the target 5G ProSe layer-3 end UE.
   3) may include the PQFI(s) and the corresponding PC5 QoS parameters optionally including the ProSe identifier(s) for the PC5 QoS flow(s) that the target 5G ProSe layer-3 end UE accepts; and
   4) may include the PC5 QoS rule(s) to indicate the packet filters of the PC5 QoS flow(s). If the PROSE DIRECT LINK MODIFICATION REQUEST message is to establish 5G ProSe UE-to-UE relay communication with additional 5G ProSe layer-2 end UE using the existing 5G ProSe direct link between the 5G ProSe layer-2 end UE and 5G ProSe layer-2 UE-to-UE relay UE, the target UE:
a) if acting as the 5G ProSe layer-2 UE-to-UE relay UE, shall perform the 5G ProSe direct link establishment procedure towards the target 5G ProSe layer-2 end UE as specified in clause 7.2.2.2; and after receiving the PROSE DIRECT LINK ESTABLISHMENT ACCEPT message from the target 5G ProSe layer-2 end UE, shall create a PROSE DIRECT LINK MODIFICATION ACCEPT message;
b) if acting as the target 5G ProSe layer-2 end UE, shall create a PROSE DIRECT LINK MODIFICATION ACCEPT message; and
c) in the PROSE DIRECT LINK MODIFICATION ACCEPT message, the target UE:
   1) if the UE acts as the target 5G ProSe layer-2 end UE:
      i) shall include the source end UE info set to the user info of the source 5G ProSe layer-2 end UE and the target end UE info set to the user info of the target 5G ProSe layer-2 end UE; or
   2) if the UE acts as the 5G ProSe layer-2 UE-to-UE relay UE:
      i) shall include the target end UE info set to the user info of the target 5G ProSe layer-2 end UE.
         If the PROSE DIRECT LINK MODIFICATION REQUEST message is to release 5G ProSe UE-to-UE relay communication with one of the peer 5G ProSe layer-3 end UEs using the shared 5G ProSe direct link between the 5G ProSe layer-3 end UE and 5G ProSe layer-3 UE-to-UE relay UE, the target UE:
a) if acting as the 5G ProSe layer-3 UE-to-UE relay UE, may initiate one of the following procedures towards the target 5G ProSe layer-3 end UE:
   1) 5G ProSe direct link release procedure as specified in clause 7.2.6.2 to release the 5G ProSe direct link with the peer 5G ProSe layer-3 end UE; or
   2) 5G ProSe direct link modification procedure as specified in clause 7.2.3.2 to remove the corresponding PC5 QoS flow(s), if the UE determines to keep the 5G ProSe direct link with the peer 5G ProSe layer-3 end UE; and
b) shall create a PROSE DIRECT LINK MODIFICATION ACCEPT message, and in this message, the target UE:
   1) shall include the source end UE info set to the user info of the source 5G ProSe layer-3 end UE, if the UE acts as the target 5G ProSe layer-3 end UE; or
   2) shall include the target end UE info set to the user info of the target 5G ProSe layer-3 end UE, if the UE acts as the 5G ProSe layer-3 UE-to-UE relay UE.
      If the 5G ProSe direct link is for 5G ProSe direct communication between the 5G ProSe remote UE and the 5G ProSe layer-3 UE-to-network relay UE, and if the initiating UE is the 5G ProSe remote UE, then the target UE (as the 5G ProSe layer-3 UE-to-network relay UE) performs the QoS flows handling procedure as specified in clause 8.2.6.3.3 and clause 8.2.6.4.2.
      The target UE shall ignore the value of the link modification operation code IE if the relay reselection indication is included in this message.
      If the PROSE DIRECT LINK MODIFICATION REQUEST message is accepted by the target 5G ProSe end UE to trigger UE-to-UE relay reselection and the 5G PC5 direct link is between the 5G ProSe UE-to-UE relay UE and the target 5G ProSe end UE, the target UE acting as the target 5G ProSe end UE may perform the candidate 5G ProSe UE-to-UE relay discovery procedure as specified in clause 8a.2.3.3. The target UE shall set up a PC5 unicast link with the selected new 5G ProSe UE-to-UE relay UE, if no such PC5 unicast link already exists.
      If the PROSE DIRECT LINK MODIFICATION REQUEST message is accepted to trigger the negotiated 5G ProSe layer-3 UE-to-UE relay reselection, the target UE shall respond with PROSE DIRECT LINK MODIFICATION ACCEPT message. In this message:
a) if the target UE acts as a target 5G ProSe layer-3 end UE and the 5G ProSe direct link is between the target 5G ProSe layer-3 end UE and the 5G ProSe layer-3 UE-to-UE relay UE, the target UE:
   1) shall include the relay reselection indication;
   2) shall include the newly selected 5G ProSe UE-to-UE relay UE user info ID;
   3) shall include the initiating 5G ProSe end UE IP address; and
   4) shall include the target 5G ProSe end UE IP address to be used with the newly selected 5G ProSe UE-to-UE relay UE, if IP communication is used; and
b) if the target UE acts as a 5G ProSe layer-3 UE-to-UE relay UE and the 5G ProSe direct link is between the 5G ProSe layer-3 UE-to-UE relay UE and the source 5G ProSe layer-3 end UE, after receiving the PROSE DIRECT LINK MODIFICATION ACCEPT message from the target 5G ProSe layer-3 end UE, the target UE.
   1) shall include the relay reselection indication;
   2) shall include the newly selected 5G ProSe UE-to-UE relay UE user info ID;
   3) shall include the target 5G ProSe end UE IP address; and
   4) shall include the target 5G ProSe end UE IP address to be used with the newly selected 5G ProSe UE-to-UE relay UE, if IP communication is used.
      If the PROSE DIRECT LINK MODIFICATION REQUEST message is accepted to trigger the negotiated 5G ProSe layer-2 UE-to-UE relay reselection, the target UE acting as the target 5G ProSe layer-2 end UE shall respond with PROSE DIRECT LINK MODIFICATION ACCEPT message. In this message:
a) shall include the relay reselection indication;
b) shall include the new 5G ProSe UE-to-UE relay UE user info ID; and
c) shall include the new LBSs of K_{NRP} ID.
   After the PROSE DIRECT LINK MODIFICATION ACCEPT message is generated, the target UE shall pass this message to the lower layers for transmission along with the initiating UE's layer-2 ID for 5G ProSe direct communication and the target UE's layer-2 ID for 5G ProSe direct communication.
   If this procedure is performed for the negotiated 5G ProSe layer-3 UE-to-UE relay reselection, the target UE shall start timer T5096. The target UE shall not send a new PROSE DIRECT LINK MODIFICATION ACCEPT message to the same initiating UE while timer T5096 is running. If the target UE accepts the 5G ProSe direct link modification request, then the target UE may perform the PC5 QoS flow establishment over 5G ProSe direct link as specified in clause 7.2.7 and perform the PC5 QoS flow match over 5G ProSe direct link as specified in clause 7.2.8. The target UE shall form the new K_{NRP} ID from the new MSBs of K_{NRP} ID received in the PROSE DIRECT LINK MODIFICATION REQUEST message and the new LSBs of K_{NRP} ID included in the PROSE DIRECT LINK MODIFICATION ACCEPT message. The target UE shall replace the existing K_{NRP} ID with the new K_{NRP} ID. The target UE may include the new K_{NRP} ID in DIRECT LINK ESTABLISHMENT REQUEST message with the initiating UE as specified in clause 7.2.2.2.

### 7.2.3.4 5G ProSe Direct Link Modification Procedure Completion by the Initiating UE

Upon receipt of the PROSE DIRECT LINK MODIFICATION ACCEPT message, the initiating UE shall stop timer T5081.
Upon receipt of the PROSE DIRECT LINK MODIFICATION ACCEPT message, if the PROSE DIRECT LINK MODIFICATION REQUEST message is to add a new ProSe application, add new PC5 Qos flow(s) or modify any existing PC5 QoS flow(s) in the 5G ProSe direct link, the initiating UE shall provide the added or modified PQFI(s) and corresponding PC5 QoS parameters along with PC5 link identifier to the lower layer.
Upon receipt of the PROSE DIRECT LINK MODIFICATION ACCEPT message, if the PROSE DIRECT LINK MODIFICATION REQUEST message is to remove an existing ProSe application or to remove the existing PC5 QoS flow(s) from the 5G ProSe direct link, the initiating UE shall provide the removed PQFI(s) along with the PC5 link identifier to the lower layer.
Upon receipt of the PROSE DIRECT LINK MODIFICATION ACCEPT message, if the initiating UE acts as the 5G ProSe layer-3 UE-to-UE relay UE and the PROSE DIRECT LINK MODIFICATION REQUEST message is to establish 5G ProSe UE-to-UE relay communication with additional 5G ProSe layer-3 end UE using the existing 5G ProSe direct link between the 5G ProSe layer-3 end UE and 5G ProSe layer-3 UE-to-UE relay UE, the initiating UE shall send a PROSE DIRECT LINK ESTABLISHMENT ACCEPT message to the source 5G ProSe layer-3 end UE as specified in clause 7.2.2.3.
Upon receipt of the PROSE DIRECT LINK MODIFICATION ACCEPT message, if the initiating UE acts as the 5G ProSe layer-3 UE-to-UE relay UE and the PROSE DIRECT LINK MODIFICATION REQUEST message is to add new PC5 QoS flow(s) or modify any existing PC5 QoS flow(s) in the existing 5G ProSe direct link or to remove any PC5 QoS flow(s) from the existing 5G ProSe direct link between the 5G ProSe layer-3 end UE and 5G ProSe layer-3 UE-to-UE relay UE, the initiating UE shall send a PROSE DIRECT LINK MODIFICATION ACCEPT message to the source 5G ProSe layer-3 end UE as specified in clause 7.2.3.3.
When the 5G ProSe direct link is between the source 5G ProSe end UE and the 5G ProSe UE-to-UE relay UE, upon receiving PROSE DIRECT LINK MODIFICATION ACCEPT message, which includes relay reselection indication, and the PROSE DIRECT LINK MODIFICATION REQUEST message is for the negotiated 5G ProSe UE-to-UE relay reselection, the initiating UE, acting as the source 5G ProSe end UE, shall set up a PC5 unicast link with the newly selected 5G ProSe UE-to-UE relay UE whose user info ID is included in the PROSE DIRECT LINK MODIFICATION ACCEPT message, if no such PC5 unicast link already exists. If the initiating UE acts as a source 5G ProSe layer-3 end UE, the initiating UE shall create a PROSE DIRECT LINK MODIFICATION ACK message. In this message, the initiating UE:
a) shall include the relay reselection indication, source end UE IP address for new relay IE set to IP address of the source 5G ProSe layer-3 end UE's IP address to be used with the newly selected 5G ProSe layer-3 UE-to-UE relay UE and target end UE IP address IE set to the IP address of the target 5G ProSe layer-3 end UE, if IP communication is used.
   When the 5G ProSe direct link is between the 5G ProSe layer-3 UE-to-UE relay UE and the target 5G ProSe layer-3 end UE, and the 5G ProSe layer-3 UE-to-UE relay UE receives PROSE DIRECT LINK MODIFICATION ACK message from the source 5G ProSe end UE which includes relay reselection indication, the 5G ProSe layer-3 UE-to-UE relay UE shall create a PROSE DIRECT LINK MODIFICATION ACK message. In this message, the 5G ProSe layer-3 UE-to-UE relay UE:
a) shall include the relay reselection indication, source end UE IP address for new relay IE set to the IP address of the source 5G ProSe layer-3 end UE to be used with the newly selected 5G ProSe layer-3 UE-to-UE relay UE, and source end UE IP address IE set to the IP address of the source 5G ProSe layer-3 end UE, if IP communication is used.
   Upon receiving PROSE DIRECT LINK MODIFICATION ACCEPT message, that includes relay reselection indication, if the PROSE DIRECT LINK MODIFICATION REQUEST message is for relay reselection, the initiating UE shall form the new K_{NRP} ID from the MSBs of K_{NRP} ID included in the PROSE DIRECT LINK MODIFICATION REQUEST message and the LSBs of K_{NRP} ID received in the PROSE DIRECT LINK MODIFICATION ACCEPT message. The initiating UE shall replace the existing K_{NRP} ID with the new K_{NRP} ID. The initiating UE may include the new K_{NRP} ID in PROSE DIRECT LINK ESTABLISHMENT REQUEST message with the target UE as specified in clause 7.2.2.2 when the initiating UE reconnects with the same target UE.
   After the PROSE DIRECT LINK MODIFICATION ACK message is generated, the initiating UE shall pass this message to the lower layers for transmission along with the initiating UE's layer-2 ID for 5G ProSe direct communication and the target UE's layer-2 ID for 5G ProSe direct communication.
   If the source UE acknowledges the 5G ProSe direct link modification accept, then the source UE starts to receive and/or transmit traffic via the newly selected 5G ProSe UE-to-UE relay UE. If the 5G ProSe direct link modification procedure is for 5G ProSe direct communication between the 5G ProSe layer-3 UE-to-UE relay UE and the target 5G ProSe layer-3 end UE, for Ethernet traffic, the PROSE DIRECT LINK MODIFICATION ACCEPT message contains target 5G ProSe layer-3 end UE MAC address, and the initiating UE acting as the 5G ProSe layer-3 UE-to-UE relay UE detects that the MAC address of the target 5G ProSe layer-3 end UE is not unique, i.e., the MAC address of the target 5G ProSe layer-3 end UE was also provided by another 5G ProSe layer-3 end UE in an existing ProSe 5G direct link, the 5G ProSe layer-3 UE-to-UE relay UE shall perform 5G ProSe direct link release procedure as specified in clause 7.2.6.

### 7.2.3.4a 5G ProSe Direct Link Modification Procedure Completion by the Target UE

Upon receipt of the PROSE DIRECT LINK MODIFICATION ACK message, the target layer-3 5G ProSe end UE starts to receive traffic, transmit traffic, or both, via the newly selected 5G ProSe UE-to-UE relay UE and shall stop T5096.
Upon receipt of the PROSE DIRECT LINK MODIFICATION ACK message, the layer-3 5G ProSe UE-to-UE relay UE shall stop T5096.

### 7.2.3.5 5G ProSe Direct Link Modification Procedure not Accepted by the Target UE

If the 5G ProSe direct link modification request cannot be accepted, the target UE shall send a PROSE DIRECT LINK MODIFICATION REJECT message. The PROSE DIRECT LINK MODIFICATION REJECT message contains a PC5 signalling protocol cause IE set to one of the following cause values:
#5 lack of resources for 5G ProSe direct link;
#6 required service not allowed;
#12 security policy not aligned;
#16 lack of local capabilities;
#20 Failure from 5G ProSe end UE;
#23 MAC address not unique;
#24 relay UE is not selected for link setup with integrated discovery; or
#111 protocol error, unspecified.
   If the target UE is not allowed to accept this request, e.g., because the ProSe application to be added is not allowed per the operator policy or configuration parameters for ProSe communication over PC5 as specified in clause 5.2.4, the target UE shall send a PROSE DIRECT LINK MODIFICATION REJECT message with PC5 signalling protocol cause value #6 “required service not allowed”.
   If the target UE is a 5G ProSe layer-3 UE-to-network relay UE, the PDU session for relaying the service is an LADN PDU session and:
a) the target UE is outside the LADN service area; or
b) the 5G ProSe direct link modification requires a PDU session modification procedure which fails due to reception of the 5GSM cause value #46 “out of LADN service area” in the PDU SESSION MODIFICATION REJECT message as specified in as specified in 3GPP TS 24.501 clause 6.4.2.4.1;
   the target UE shall send a PROSE DIRECT LINK MODIFICATION REJECT message with PC5 signalling protocol cause value #111 “protocol error, unspecified”.
   If the 5G ProSe direct link modification fails due to the congestion problems or other temporary lower layer problems causing resource constraints, the target UE shall send a PROSE DIRECT LINK MODIFICATION REJECT message with PC5 signalling protocol cause value #5 “lack of resources for 5G ProSe direct link”.
   If the target UE acting as a target 5G ProSe end UE, receives one or more direct link modification request or direct link establishment request for end-to-end connection setup with the source 5G ProSe end UE and integrated discovery is used, then the target UE shall select a 5G ProSe UE-to-UE relay UE and send a PROSE DIRECT LINK MODIFICATION REJECT message to the 5G ProSe UE-to-UE Relay which is not selected and which has sent the PROSE DIRECT LINK MODIFICATION REQUEST message, with PC5 signalling protocol cause value #24 “relay UE is not selected for link setup with integrated discovery”.
   If the link modification operation code is set to “Associate new ProSe application(s) with existing PC5 QoS flow(s)” and the security policy corresponding to the ProSe identifier(s) is not aligned with the security policy applied to the existing 5G ProSe direct link, then the target UE shall send a PROSE DIRECT LINK MODIFICATION REJECT message with PC5 signalling protocol cause value #12 “security policy not aligned”.
   If the link modification operation requires the addition of new PC5 QoS flow(s) but the target UE cannot support additional packet filters which would be required on the existing PDU session of the target UE, then the target UE shall send a PROSE DIRECT LINK MODIFICATION REJECT message with PC5 signalling protocol cause value #16 “lack of local capabilities”. If the target UE is acting as a target 5G ProSe end UE and the 5G ProSe direct link modification procedure is between the 5G ProSe UE-to-UE relay UE and the target 5G ProSe end UE, the target 5G ProSe end UE may include in the PROSE DIRECT LINK MODIFICATION REJECT message the source end UE info IE set to the user info of the source 5G ProSe end UE that has initiated the 5G ProSe direct link establishment procedure.
   If the target UE is acting as a 5G ProSe UE-to-UE relay UE, the 5G ProSe direct link modification procedure is between the source 5G ProSe end UE and the 5G ProSe UE-to-UE relay UE, and the target 5G ProSe end UE has rejected the 5G ProSe direct link establishment procedure or the 5G ProSe direct link modification procedure, then the 5G ProSe UE-to-UE relay UE shall send a PROSE DIRECT LINK MODIFICATION REJECT message with PC5 signalling protocol cause value #20 “Failure from 5G ProSe end UE” to the source 5G ProSe end UE. The 5G ProSe UE-to-UE relay UE may include in the PROSE DIRECT LINK MODIFICATION REJECT message the PC5 end UE failure cause IE set to the PC5 signalling protocol cause received from the target 5G ProSe end UE that has rejected the 5G ProSe direct link establishment procedure as specified in clause 7.2.2.5. The 5G ProSe UE-to-UE relay UE may include in the PROSE DIRECT LINK MODIFICATION REJECT message the target end UE info IE set to the user info of the target 5G ProSe end UE that has rejected the 5G ProSe direct link establishment procedure.
   For other reasons causing the failure of link modification, the target UE shall send a PROSE DIRECT LINK MODIFICATION REJECT message with PC5 signalling protocol cause value #111 “protocol error, unspecified”.
   Upon receipt of the PROSE DIRECT LINK MODIFICATION REJECT message, the initiating UE shall stop timer T5081 and abort the 5G ProSe direct link modification procedure. If the PC5 signalling protocol cause value in the PROSE DIRECT LINK MODIFICATION REJECT message is #11 “required service not allowed” or #5 “lack of resources for 5G ProSe direct link” or #12 “security policy not aligned”, then the initiating UE shall not attempt to start 5G ProSe direct link modification with the same target UE to add the same ProSe application, or to add or modify the same PC5 QoS flow(s) at least for a time period T.
NOTE: The length of time period T is UE implementation specific and can be different for the case when the UE receives PC5 signalling protocol cause value #11 “required service not allowed” or when the UE receives PC5 signalling protocol cause value #5 “lack of resources for 5G ProSe direct link” or when the UE receives PC5 signalling protocol cause value #12 “security policy not aligned”. The length of time period T is not less than 30 minutes.
   If the 5G ProSe direct link modification procedure is for 5G ProSe direct communication between the source 5G ProSe layer-3 end UE and the 5G ProSe layer-3 UE-to-UE relay UE, for Ethernet traffic, the PROSE DIRECT LINK MODIFICATION REQUEST message contains source 5G ProSe layer-3 end UE MAC address, and the target UE acting as the 5G ProSe layer-3 UE-to-UE relay UE detects that the MAC address of the source 5G ProSe layer-3 end UE is not unique, i.e., the MAC address of the source 5G ProSe layer-3 end UE was also provided by another 5G ProSe layer-3 end UE in an existing ProSe 5G direct link, the 5G ProSe layer-3 UE-to-UE relay UE shall send a PROSE DIRECT LINK MODIFICATION REJECT message containing PC5 signalling protocol cause value #23 “MAC address not unique” to the source 5G ProSe layer-3 end UE.
   If the 5G ProSe direct link establishment procedure is for 5G ProSe direct communication between the source 5G ProSe layer-3 end UE and the 5G ProSe layer-3 UE-to-UE relay UE, for Ethernet traffic, and the target UE acting as the 5G ProSe layer-3 UE-to-UE relay UE releases the 5G ProSe direct link between the 5G ProSe layer-3 UE-to-UE relay UE and the target 5G ProSe layer-3 end UE with PC5 signalling protocol cause value #23 “MAC address not unique”, the 5G ProSe layer-3 UE-to-UE relay UE shall send a the PROSE DIRECT LINK MODIFICATION REJECT message containing PC5 signalling protocol cause value #111 “protocol error, unspecified” to the source 5G ProSe layer-3 end UE.

### 7.2.3.6 Abnormal Cases

### 7.2.3.6.1 Abnormal Cases at the Initiating UE

The following abnormal cases can be identified:
a) If timer T5081 expires, the initiating UE shall retransmit the PROSE DIRECT LINK MODIFICATION REQUEST message and restart timer T5081. After reaching the maximum number of allowed retransmissions, the initiating UE shall abort the 5G ProSe direct link modification procedure and may notify the upper layer that the target UE is unreachable.
NOTE 1: The maximum number of allowed retransmissions is UE implementation specific.
NOTE 2: After reaching the maximum number of allowed retransmissions, whether the initiating UE releases this 5G ProSe direct link depends on its implementation.
b) For the same 5G ProSe direct link, if the initiating UE receives a PROSE DIRECT LINK RELEASE REQUEST message after the initiation of UE-requested 5G ProSe direct link modification procedure, the initiating UE shall stop the timer T5081 and abort the 5G ProSe direct link modification procedure and proceed with the 5G ProSe direct link release procedure.
c) For the same 5G ProSe direct link, if the initiating UE receives a PROSE DIRECT LINK MODIFICATION REQUEST message during the 5G ProSe direct link modification procedure, the initiating UE shall stop the timer T5081 and abort the 5G ProSe direct link modification procedure. Following handling is implementation dependent, e.g., the initiating UE waits for an implementation dependent time for initiating a new 5G ProSe direct link modification procedure, if still needed.
NOTE 3: The implementation dependent timer value needs to be set to avoid further collisions (e.g., random timer value).

### 7.2.3.6.2 Abnormal Cases at the Target UE

The following abnormal cases can be identified:
a) For the same 5G ProSe direct link, if the target UE receives a PROSE DIRECT LINK RELEASE REQUEST message during the 5G ProSe direct link modification procedure, the target UE shall stop all running timers for this 5G ProSe direct link, abort the 5G ProSe direct link modification procedure and proceed with the 5G ProSe direct link release procedure.
   [ . . . ]

### 7.2.6.2 5G ProSe Direct Link Release Procedure Initiation by Initiating UE

The initiating UE shall initiate the procedure if a request from upper layers to release a 5G ProSe direct link with the target UE which uses a known layer-2 ID (for unicast communication) is received and there is an existing 5G ProSe direct link between these two UEs.
The initiating UE may initiate the procedure if the target UE has been non-responsive, e.g., no response in the 5G ProSe direct link modification procedure, 5G ProSe direct link identifier update procedure, 5G ProSe direct link re-keying procedure or 5G ProSe direct link keep-alive procedure.
The initiating UE may initiate the procedure to release an established 5G ProSe direct link if the UE has reached the maximum number of established 5G ProSe direct links and there is a need to establish a new 5G ProSe direct link. In this case, which 5G ProSe direct link is to be released is up to UE implementation.
The initiating UE may initiate the procedure to release an established 5G ProSe direct link upon expiry of the timer T5084.

### If:

a) the initiating UE acts as 5G ProSe layer-3 UE-to-network relay UE; and
b) the PDU session established for relaying the traffic of the target UE is released by the initiating UE or the network as specified in 3GPP TS 24.501 clause 6.3.3 or clause 6.4.3;
   the initiating UE should initiate the 5G ProSe direct link release procedure.
   If the initiating UE which is acting as 5G ProSe layer-3 UE-to-network relay UE establishes a new PDU session after receiving 5GSM cause value #39 “reactivation requested” as specified in 3GPP TS 24.501 clause 6.3.2.3, the UE may initiate the 5G ProSe direct link release procedure.
   If the initiating UE is a 5G ProSe layer-3 UE-to-network relay UE, the PDU session for relaying the service is an LADN PDU session and:
a) the UE is outside the LADN service area; or
b) the UE receives the 5GSM cause value #46 “out of LADN service area” in the PDU SESSION MODIFICATION REJECT message as specified in as specified in 3GPP TS 24.501 clause 6.4.2.4.1;
   and there is at least one 5G ProSe layer-3 remote UE which is served on the PDU session, then the UE should initiate the 5G ProSe direct link release procedure.

### If:

a) the initiating UE acts as 5G ProSe layer-2 remote UE or 5G ProSe layer-3 remote UE for relay with N3IWF support; and
b) the initiating UE is in 5GMM-IDLE mode;
   the initiating UE may initiate the 5G ProSe direct link release procedure.

### If:

a) the initiating UE acts as 5G ProSe layer-2 remote UE, 5G ProSe layer-3 remote UE or 5G ProSe layer-2 UE-to-network relay UE; and
b) the service authorization for the initiating UE to act as 5G ProSe layer-2 remote UE, 5G ProSe layer-3 remote UE or 5G ProSe layer-2 UE-to-network relay UE is revoked after receiving the configuration parameters for 5G ProSe UE-to-network relay as specified in clause 5.2.5;
   the initiating UE should initiate the 5G ProSe direct link release procedure.

### If:

a) the initiating UE acts as 5G ProSe layer-3 UE-to-network relay UE; and
b) the service authorization for the initiating UE to act as 5G ProSe layer-3 UE-to-network relay UE in the serving PLMN is revoked after receiving the configuration parameters for 5G ProSe UE-to-network relay as specified in clause 5.2.5;
   the initiating UE should initiate the 5G ProSe direct link release procedure, and the initiating UE releases the PDU session established for relaying the traffic of the target UE as specified in 3GPP TS 24.501 clause 6.4.3.

### If:

a) the initiating UE acts as 5G ProSe layer-3 UE-to-network relay UE;
b) the 5G ProSe direct link was established with an RSC that is specific for emergency services; and
c) the initiating UE becomes involved into its own emergency services as specified in 3GPP TS 24.501 and the initiating UE decides to prioritize its own emergency services due to local regulations or implementation specific requirements;
   the initiating UE shall initiate the 5G ProSe direct link release procedure, and the initiating UE releases the PDU session established for relaying the traffic of the target UE as specified in 3GPP TS 24.501 clause 6.4.3.

### If:

a) the initiating UE acts as 5G ProSe end UE or 5G ProSe UE-to-UE relay UE; and
b) the service authorization for the initiating UE to act as 5G ProSe end UE or 5G ProSe UE-to-UE relay UE is revoked after receiving the configuration parameters for 5G ProSe UE-to-UE relay as specified in clause 5.2.7;
   the initiating UE should initiate the 5G ProSe direct link release procedure.

### If:

a) the initiating UE is acting as a 5G ProSe layer-3 UE-to-UE relay UE;
b) the direct link that is between a 5G ProSe layer-3 end UE and the initiating UE has been released; and
c) there are one or more direct links between the initiating UE and the peer 5G ProSe layer-3 end UEs that have PC5 QoS flow(s) only for the communication with the 5G ProSe layer-3 end UE;
   the initiating UE may initiate the 5G ProSe direct link release procedure toward the peer 5G ProSe layer-3 end UEs.

### If:

a) the initiating UE is acting as a 5G ProSe layer-3 UE-to-UE relay UE;
b) a PROSE DIRECT LINK MODIFICATION REQUEST message is received from a 5G ProSe layer-3 end UE to release 5G ProSe UE-to-UE relay communication with one of the peer 5G ProSe layer-3 end UEs; and
c) the 5G ProSe direct link between the initiating UE and the target peer 5G ProSe layer-3 end UE has PC5 QoS flow(s) only for the communication with the 5G ProSe layer-3 end UE;
   the initiating UE may initiate the 5G ProSe direct link release procedure toward the target peer 5G ProSe layer-3 end UE.
   For 5G ProSe layer-2 UE-to-UE relay, if:
a) the initiating UE is acting as a 5G ProSe layer-2 end UE;
b) the initiating UE has released the end-to-end 5G ProSe direct link between the initiating UE and its peer 5G ProSe layer-2 end UE; and
c) the 5G ProSe direct link between the initiating UE and the 5G ProSe layer-2 UE-to-UE relay UE has PC5 QoS flow(s) only for the end-to-end communication between the initiating UE and its peer 5G ProSe layer-2 end UE;
   the initiating UE may initiate the 5G ProSe direct link release procedure toward the 5G ProSe layer-2 UE-to-UE relay UE.
   If the 5G ProSe direct link is for 5G ProSe direct communication between the 5G ProSe layer-3 UE-to-UE relay UE and the target 5G ProSe layer-3 end UE, for Ethernet traffic, and the initiating UE acting as the 5G ProSe layer-3 UE-to-UE relay UE detects that the MAC address of 5G ProSe layer-3 end UE is not unique, i.e., the MAC address of the target 5G ProSe layer-3 end UE was also provided by another 5G ProSe layer-3 end UE in an existing ProSe 5G direct link, the 5G ProSe layer-3 UE-to-UE relay UE shall send a PROSE DIRECT LINK RELEASE REQUEST message containing PC5 signalling protocol cause value #23 “MAC address not unique” to the target 5G ProSe layer-3 end UE.
   [ . . . ]

### 10.3.2 ProSe Direct Link Establishment Accept

### 10.3.2.1 Message Definition

This message is sent by a UE to another peer UE to accept the received PROSE DIRECT LINK ESTABLISHMENT REQUEST message. See table 10.3.2.1.1.
Message type: PROSE DIRECT LINK ESTABLISHMENT ACCEPT
Significance: dual
Direction: UE to peer UE

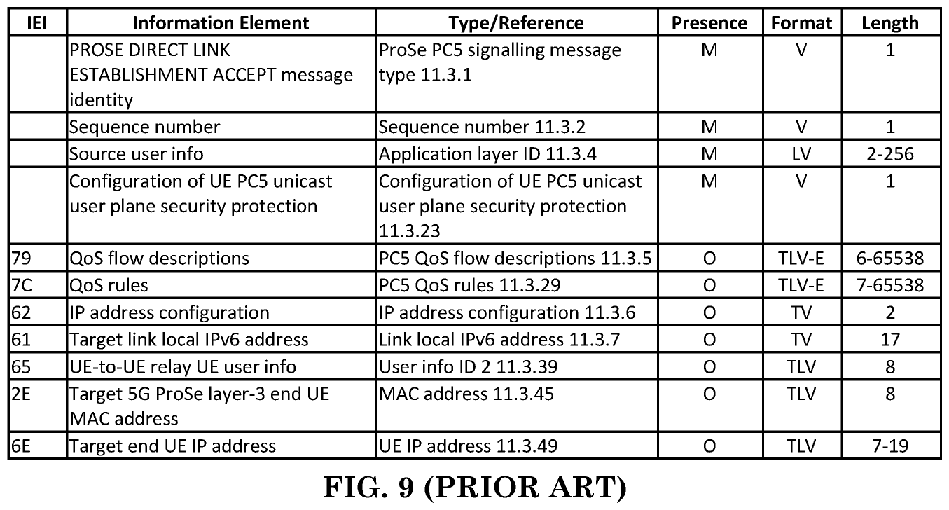

### [Table 10.3.2.1.1 of 3GPP TS 23.554 V18.8.0, Entitled “PROSE DIRECT LINK ESTABLISHMENT ACCEPT Message Content”, is Reproduced as FIG. 9]

### 10.3.6 ProSe Direct Link Modification Request

### 10.3.6.1 Message Definition

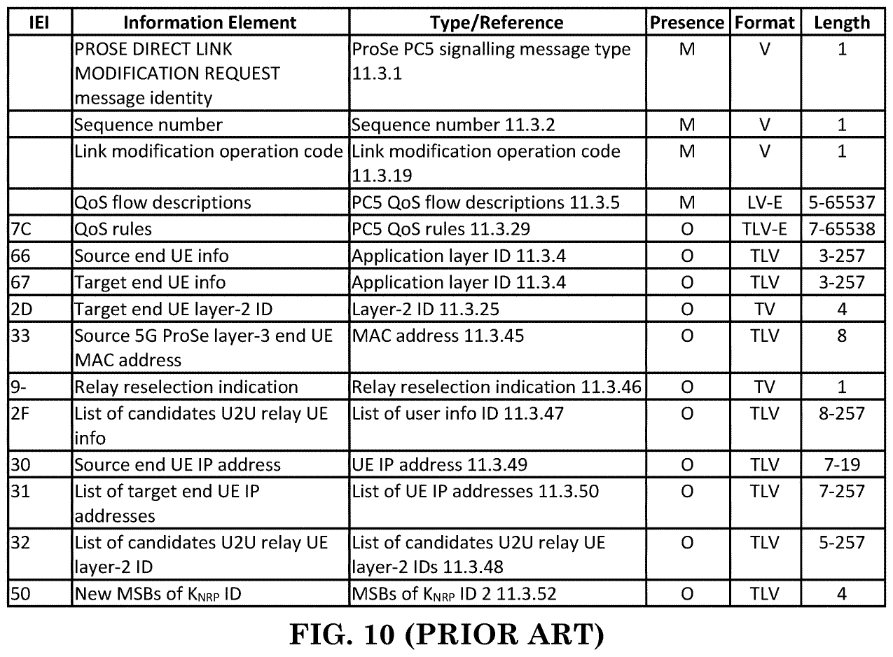

This message is sent by the UE to another peer UE to initiate the direct link modification procedure. See table 10.3.6.1.1.
Message type: PROSE DIRECT LINK MODIFICATION REQUEST
Significance: dual
Direction: UE to peer UE
   [Table 10.3.6.1.1 of 3GPP TS 23.554 V18.8.0, entitled “PROSE DIRECT LINK MODIFICATION REQUEST message content”, is reproduced as FIG. 10]

### 10.3.14 ProSe Direct Link Security Mode Complete

### 10.3.14.1 Message Definition

This message is sent by a UE to another peer UE to respond to a PROSE DIRECT LINK SECURITY MODE COMMAND message. See table 10.3.14.1.1.
Message type: PROSE DIRECT LINK SECURITY MODE COMPLETE
Significance: dual
Direction: UE to peer UE

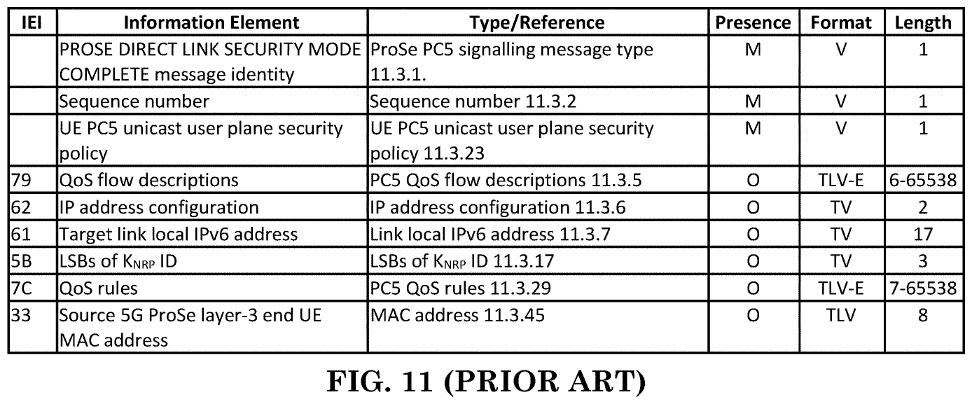

### [Table 10.3.14.1.1 of 3GPP TS 23.554 V18.8.0, Entitled “PROSE DIRECT LINK SECURITY MODE COMPLETE Message Content”, is Reproduced as FIG. 11]

UE-to-UE (U2U) Relay was specified in Release 18. A relay UE may be used to support connectivity between an end UE and a peer UE if the end UE cannot communicate with the peer UE directly. A first end UE (i.e. source (5G ProSe) end UE) could trigger a layer-2 link establishment procedure (as introduced in e.g. clause 6.7 in 3GPP TS 23.304) for supporting UE-to-UE relay communication between the first end UE and a second end UE (i.e. target (5G ProSe) end UE) via a (5G ProSe UE-to-UE) relay UE. The relay UE could establish one PC5 direct link with the source end UE (e.g. on first PC5 hop) and one PC5 direct link with the target end UE (e.g. on second PC5 hop), respectively. In 3GPP TS 23.304, two types of layer-2 link establishment procedures are specified. For the layer-2 link establishment procedure without integrated discovery, the source end UE may perform standalone 5G ProSe UE-to-UE relay discovery procedure first. The source end UE could then send a Direct Communication Request (DCR) message towards the target end UE via a specific relay UE, whose layer-2 ID (L2ID) and user info ID have been received from the latest discovery procedure.

On the other hand, the layer-2 link establishment procedure with integrated discovery may be used if the layer-2 link establishment procedure could be initiated towards any relay UE and/or if the source end UE has not yet discovered any relay UE. More specifically, the first end UE broadcasts a Direct Communication Request (DCR) message including a relay_indication. The relay_indication in the DCR is used to indicate whether the relay UE can forward the DCR message or not. Upon reception of receiving the DCR message with relay_indication from the first end UE, the relay UE may decide to participate in the procedure and broadcast a DCR message (i.e, on second hop) in its proximity without relay_indication. In response to the reception of DCR messages which contain the same source user info, ProSe identifier(s) and relay service code (RSC) as received from multiple 5G ProSe UE-to-UE relay UEs, the target end UE selects one of the 5G ProSe UE-to-UE relay UEs via which to communicate with the source end UE. After that, the target end UE establishes the security on the second hop and sends the Direct Communication Accept (DCA) to the selected relay UE for completing the layer-2 link establishment on the second hop. In response to reception of the DCA message on the second hop, the relay UE establishes the security on the first hop and send the DCA to the source end UE to complete the layer-2 link establishment on the first hop.

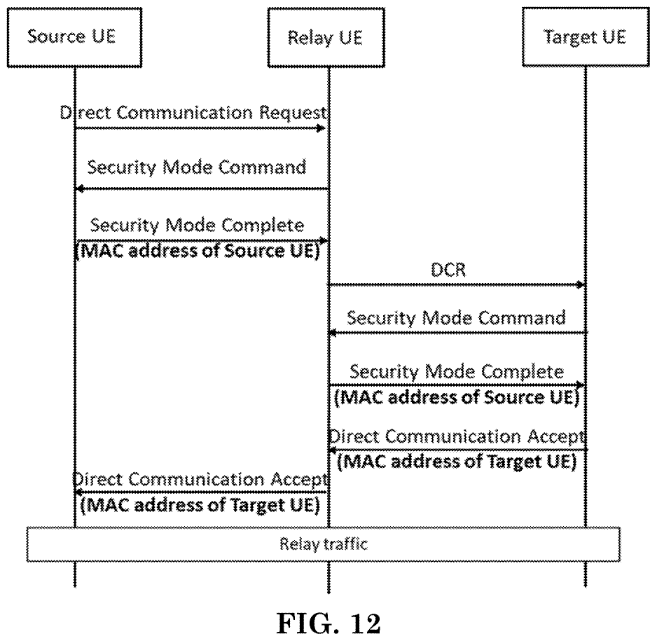

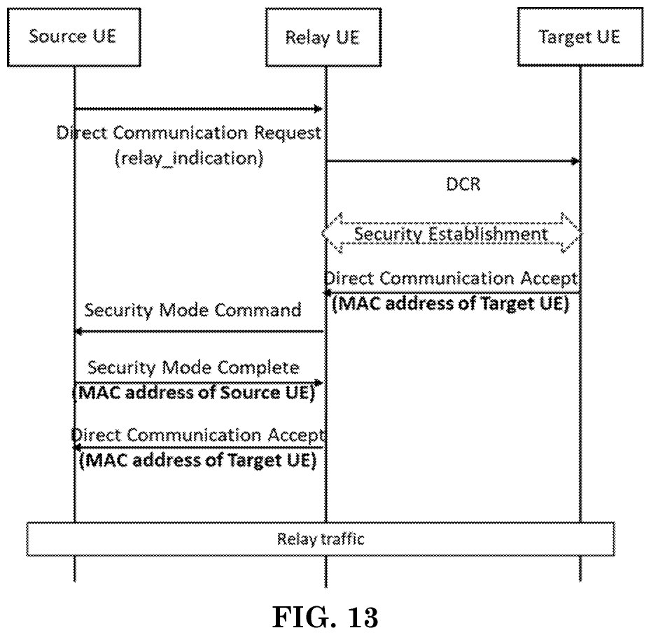

During the link establishment procedure, if the data unit type for the communication is Ethernet, the MAC addresses of the source end UE and target end UE are exchanged via the relay UE. FIG. 12 and FIG. 13 illustrate the procedure for exchanging MAC addresses with and without integrated discovery, respectively. FIG. 12 illustrates exchanging MAC address for relay communication without integrated discovery according to one exemplary embodiment. FIG. 13 illustrates exchanging MAC address for relay communication with integrated discovery according to one exemplary embodiment.

As specified in clause 7.2.2 of 3GPP TS 24.554, the relay UE shall detect if Ethernet MAC address conflicts. For example, when the relay UE detects that the MAC address of the source end UE in the PROSE DIRECT LINK SECURITY MODE COMPLETE message is not unique (i.e., the MAC address of the source end UE was also provided by another end UE in an existing ProSe 5G direct link), the relay UE shall send a PROSE DIRECT LINK ESTABLISHMENT REJECT message containing PC5 signalling protocol cause value #23 “MAC address not unique” to the source end UE. As another example, when the relay UE detects that the MAC address of the target end UE in the PROSE DIRECT LINK ESTABLISHMENT ACCEPT message is not unique, the relay UE shall initiate the 5G ProSe direct link release procedure to the target end UE and send a PROSE DIRECT LINK ESTABLISHMENT REJECT message containing PC5 signalling protocol cause value #111 “protocol error, unspecified” to the source end UE.

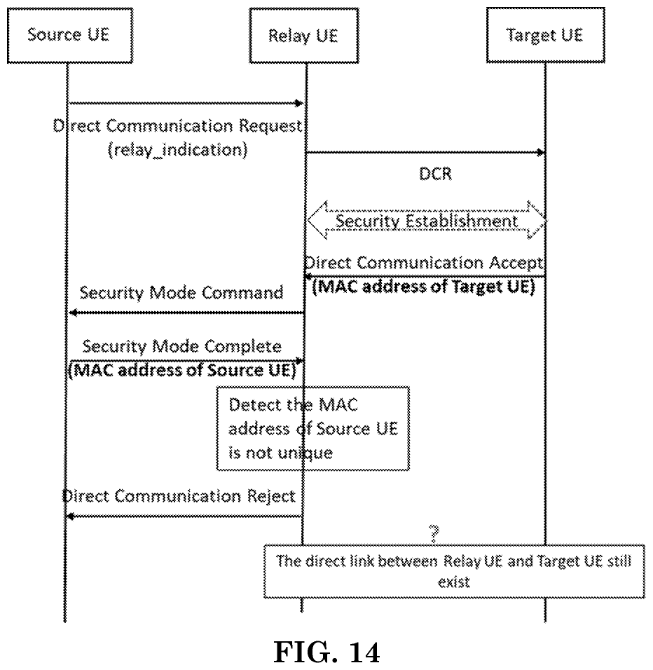

It is noted that in the case of the link establishment procedure with integrated discovery, when the relay UE detects that the MAC address of the source end UE in the PROSE DIRECT LINK SECURITY MODE COMPLETE message is not unique and send a PROSE DIRECT LINK ESTABLISHMENT REJECT message containing PC5 signaling protocol cause value #23 “MAC address not unique” to the source end UE, the direct link between the relay UE and the target end UE (i.e., the second hop) has already been established. However, further actions related to this established direct link are not specified. Without additional procedures, the direct link context may still store in the target end UE, causing the target end UE to continue waiting for traffic over this link. The behavior appears to be unnecessary and/or unintended. FIG. 14 illustrates the issue described above. To address this issue, some potential solutions could be considered.

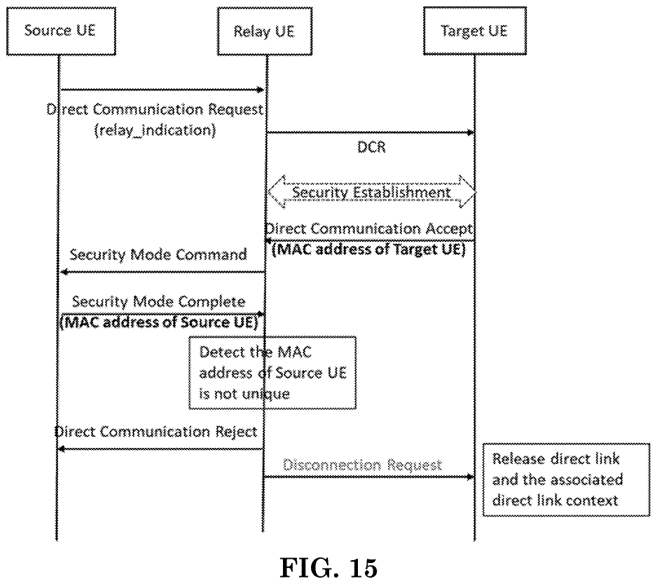

For example, when the relay UE detects a MAC address conflict, it may additionally send a PROSE DIRECT LINK RELEASE REQUEST to the target end UE. The PROSE DIRECT LINK RELEASE REQUEST message may include PC5 signaling protocol cause value #111 “protocol error, unspecified”. Upon receiving this message, the target end UE may delete the associated direct link context and may notify lower layer that the associated PC5 link is released. FIG. 15 illustrates the proposed method.

Here is a text proposal for 3GPP TS 24.554:

| | |
|---|---|
| 7.2.2.5 | 5G ProSe direct link establishment procedure not accepted by the |
| | target UE |

```
  <omitted>
If the 5G ProSe direct link establishment procedure is for 5G ProSe direct communication
between the source 5G ProSe layer-3 end UE and the 5G ProSe layer-3 UE-to-UE relay UE,
for Ethernet traffic, and the target UE acting as the 5G ProSe layer-3 UE-to-UE relay UE
detects that the MAC address of the source 5G ProSe layer-3 end UE in the the PROSE
DIRECT LINK SECURITY MODE COMPLETE message is not unique, i.e., the MAC
address of the source 5G ProSe layer-3 end UE was also provided by another 5G ProSe layer-
3 end UE in an existing ProSe 5G direct link, the 5G ProSe layer-3 UE-to-UE relay UE shall
send a PROSE DIRECT LINK ESTABLISHMENT REJECT message containing PC5
signalling protocol cause value #23 “MAC address not unique” to the source 5G ProSe layer-3
end UE.
If the 5G ProSe direct link establishment procedure is for 5G ProSe direct communication
between the source 5G ProSe layer-3 end UE and the 5G ProSe layer-3 UE-to-UE relay UE
with integrated discovery, for Ethernet traffic, and the target UE acting as the 5G ProSe layer-
3 UE-to-UE relay UE detects that the MAC address of the source 5G ProSe layer-3 end UE in
the PROSE DIRECT LINK SECURITY MODE COMPLETE message is not unique, i.e., the
MAC address of the source 5G ProSe layer-3 end UE was also provided by another 5G ProSe
layer-3 end UE in an existing ProSe 5G direct link, the 5G ProSe layer-3 UE-to-UE relay UE
shall perform 5G ProSe direct link release procedure towards the target 5G ProSe layer-3 end
UE as specified in clause 7.2.6.
If the 5G ProSe direct link establishment procedure is for 5G ProSe direct communication
between the source 5G ProSe layer-3 end UE and the 5G ProSe layer-3 UE-to-UE relay UE,
for Ethernet traffic, and the target UE acting as the 5G ProSe layer-3 UE-to-UE relay UE
releases the 5G ProSe direct link between the 5G ProSe layer-3 UE-to-UE relay UE and the
target 5G ProSe layer-3 end UE with PC5 signalling protocol cause value #23 “MAC address
not unique”, the 5G ProSe layer-3 UE-to-UE relay UE shall send a PROSE DIRECT LINK
ESTABLISHMENT REJECT message containing PC5 signalling protocol cause value #111
“protocol error, unspecified” to the source 5G ProSe layer-3 end UE.
  <omitted>
```

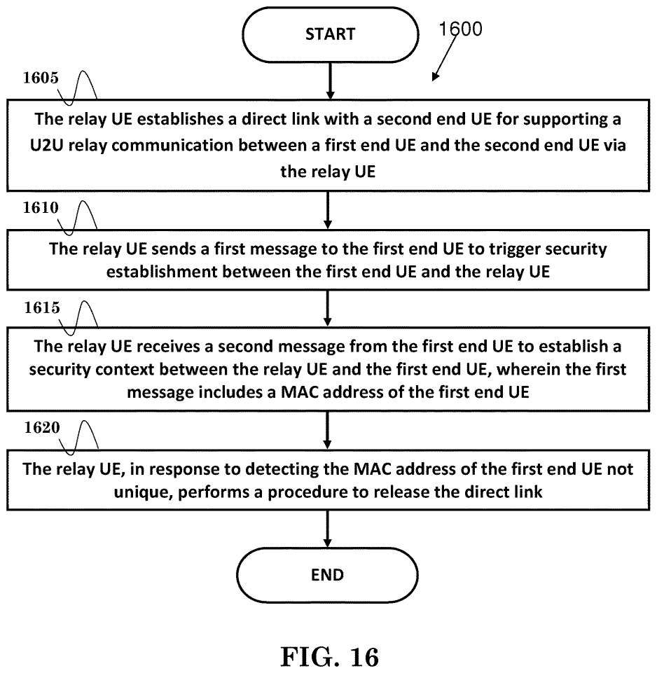

FIG. 16 is a flow chart 1600 for a relay User Equipment (UE). In step 1605, the relay UE establishes a direct link with a second end UE for supporting a UE-to-UE (U2U) relay communication between a first end UE and the second end UE via the relay UE. In step 1610, the relay UE sends a first message to the first end UE to trigger security establishment between the first end UE and the relay UE. In step 1615, the relay UE receives a second message from the first end UE to establish a security context between the relay UE and the first end UE, wherein the first message includes a Medium Access Control (MAC) address of the first end UE. In step 1620, the relay UE, in response to detecting the MAC address of the first end UE not unique, performs a procedure to release the direct link.

In one embodiment, in response to detecting the MAC address of the first end UE not unique, the relay UE could send a third message to the second end UE for releasing the direct link. The relay UE could receive a request message of a link establishment procedure from the first end UE, wherein the request message is used for 5G ProSe UE-to-UE Relay Communication with integrated discovery. In one embodiment, the request message may include a relay_indication. The request message may not include information used to identifying any UE-to-UE Relay.

In one embodiment, in response to detecting the MAC address of the first end UE is not unique, the relay UE could send a fourth message to the first end UE for rejecting the link establishment procedure between the relay UE and the first end UE. In one embodiment, the third/fourth message could include a cause value or an information indicating the MAC address of the first end UE is not unique. The first message could be a PROSE DIRECT LINK SECURITY MODE COMMAND message. The second message could be a PROSE DIRECT LINK SECURITY MODE COMPLETE message. The third message could be a PROSE DIRECT LINK RELEASE REQUEST message. The fourth message could be a PROSE DIRECT LINK ESTABLISHMENT REJECT message.

In one embodiment, the request message may be a Direct Communication Request message or a PROSE DIRECT LINK ESTABLISHMENT REQUEST message. The direct link may be a PC5 connection, PC5-S connection, PC5-RRC connection, or layer-2 link.

In one embodiment, the first end UE may be a source 5G ProSe (layer-3) End UE. The second end UE may be a target 5G ProSe (layer-3) End UE. The relay UE may be a 5G ProSe (layer-3) UE-to-UE relay UE. The procedure to release the direct link may be a 5G ProSe direct link release procedure.

Referring back to FIGS. 3 and 4, in one exemplary embodiment from the perspective of a relay UE. The relay UE 300 includes a program code 312 stored in the memory 310. The CPU 308 could execute program code 312 to enable the relay UE (i) to establish a direct link with a second end UE for supporting a U2U relay communication between a first end UE and the second end UE via the relay UE, (ii) to send a first message to the first end UE to trigger security establishment between the first end UE and the relay UE, (iii) to receive a second message from the first end UE to establish a security context between the relay UE and the first end UE, wherein the first message includes a MAC address of the first end UE, and (iv) to perform, in response to detecting the MAC address of the first end UE not unique, a procedure to release the direct link. Furthermore, the CPU 308 can execute the program code 312 to perform all of the above-described actions and steps or others described herein.

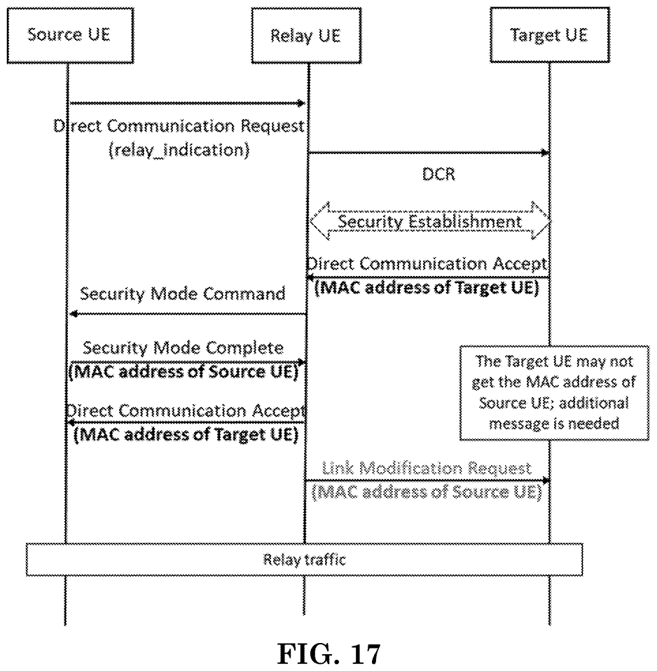

On the other hand, in the case of the link establishment procedure with integrated discovery, according to the current specification, the target end UE may not receive the MAC address of the source end UE via the relay UE. This is because the relay UE receives the MAC address of the source end UE until it receives the PROSE DIRECT LINK SECURITY MODE COMPLETE message, which occurs after the link between the relay UE and the target end UE has been established. In order to provide the missing information (e.g. the MAC address of the source end UE), upon receiving the MAC address of the source end UE, the relay UE may additionally include the MAC address of the source end UE in a link modification procedure toward the target end UE. The MAC address of the source end UE may be included in an information element of a signaling (e.g. Link Modification Request message or PROSE DIRECT LINK MODIFICATION REQUEST message) sent within the link modification procedure. FIG. 17 illustrates the proposed possible method.

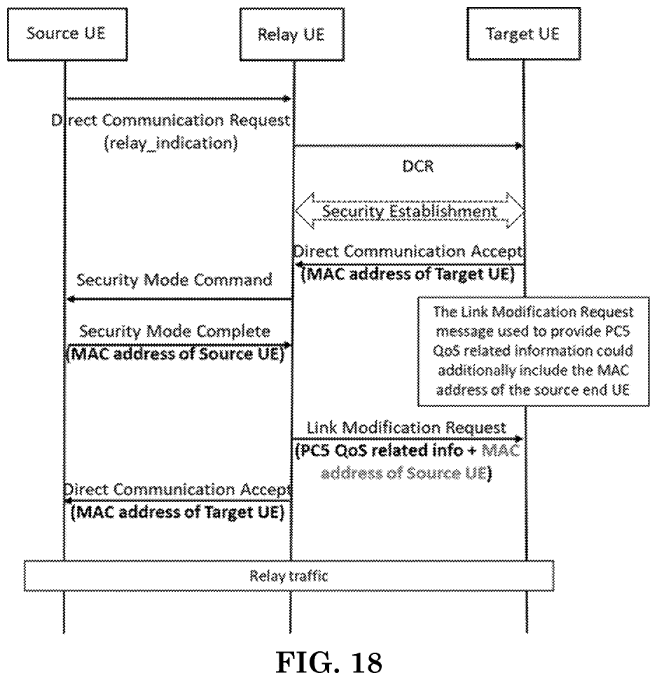

As introduced in clause 6.7.3.2 of 3GPP TS 23.304, a link modification procedure between the relay UE and the target end UE is performed after the security mode control procedure between the source end UE and the relay UE is completed (and before sending the DCA message to the source end UE). In this link modification procedure, the relay UE is to provide PC5 Quality of Service (QoS) related information over the second hop to the target end UE. However, it could be considered that the MAC address of the source end UE could be alternatively provided to the target end UE along with the PC5 QoS related information over the second hop. For example, the Link Modification Request message of the link modification procedure between the relay UE and the target end UE could include the MAC address of the source end UE in addition to the PC5 QoS related information over the second hop. FIG. 18 could illustrate the alternative.

Here is a text proposal for 3GPP TS 24.554:

| 7.2.3.2 | 5G ProSe direct link modification procedure initiated by initiating |
|---|---|
| | UE |

<omitted>
If the 5G ProSe direct link modification procedure is to add new PC5 QoS flow(s) to the
existing 5G ProSe direct link, the initiating UE shall create a PROSE DIRECT LINK
MODIFICATION REQUEST message. In this message, initiating UE:

| a) | shall include the PQFI(s), the corresponding PC5 QoS parameters and optionally the | |
|---|---|---|
| | ProSe identifier(s); | |
| b) | shall include the link modification operation code set to “Add new PC5 QoS flow(s) to | |
| | the existing 5G ProSe direct link”; | |
| c) | may include the PC5 QoS rule(s) to indicate the packet filters of the PC5 QoS flow(s); | |
| d) | shall include the source end UE info set to the user info of the source 5G ProSe layer-3 | |
| | end UE, if the UE acts as a 5G ProSe layer-3 UE-to-UE relay UE, the 5G ProSe direct | |
| | link is between the 5G ProSe layer-3 UE-to-UE relay UE and the target 5G ProSe layer- | |
| | 3 end UE, and multiple source 5G ProSe layer-3 end UEs have established direct | |
| | communication with the target 5G ProSe layer-3 end UE via the 5G ProSe layer-3 UE- | |
| | to-UE relay UE using the same 5G ProSe direct link; | |
| e) | may include the source end UE info set to the user info of the source 5G ProSe end UE, | |
| | if the UE acts as a 5G ProSe UE-to-UE relay UE, the 5G ProSe direct link is between | |
| | the 5G ProSe UE-to-UE relay UE and the target 5G ProSe end UE, and only one source | |
| | 5G ProSe end UE has established direct communication with the target 5G ProSe end | |
| | UE via the 5G ProSe UE-to-UE relay UE using the 5G ProSe direct link; | |
| f) | shall include the target end UE info set to the user info of the target 5G ProSe layer-3 | |
| | end UE, if the UE acts as a source 5G ProSe layer-3 end UE, the 5G ProSe direct link is | |
| | between the source 5G ProSe layer-3 end UE and the 5G ProSe layer-3 UE-to-UE relay | |
| | UE, and the source 5G ProSe layer-3 end UE has established direct communication with | |
| | multiple target 5G ProSe layer-3 end UEs via the 5G ProSe layer-3 UE-to-UE relay UE | |
| | using the same 5G ProSe direct link; | |
| g) | may include the target end UE info set to the user info of the target 5G ProSe end UE, if: | |
| | 1) | the UE acts as a source 5G ProSe end UE, the 5G ProSe direct link is between the |
| | | source 5G ProSe end UE and the 5G ProSe UE-to-UE relay UE, and the source 5G |
| | | ProSe end UE has established direct communication with only one target 5G ProSe |
| | | end UE via the 5G ProSe UE-to-UE relay UE using the 5G ProSe direct link; or |
| | 2) | the UE acts as a 5G ProSe UE-to-UE relay UE and the 5G ProSe direct link is |
| | | between the 5G ProSe UE-to-UE relay UE and the target 5G ProSe end UE; and |

| | |
|---|---|
| h) | may include the target end UE layer-2 ID set to the layer-2 ID of the target 5G ProSe |
| | end UE, if the UE acts as a source 5G ProSe end UE and the 5G ProSe direct link is |
| | between the source 5G ProSe end UE and the 5G ProSe UE-to-UE relay UE; [symbol] |
| i) | for Ethernet traffic, shall include the MAC address of the source 5G ProSe layer-3 end |
| | UE, if the 5G ProSe direct link modification procedure was triggered during a 5G ProSe |
| | direct link establishment procedure with integrated discovery, the UE acts as a 5G ProSe |
| | layer-3 UE-to-UE relay UE and the 5G ProSe direct link is between the 5G ProSe layer- |
| | 3 UE-to-UE relay UE and the target 5G ProSe layer-3 end UE. |

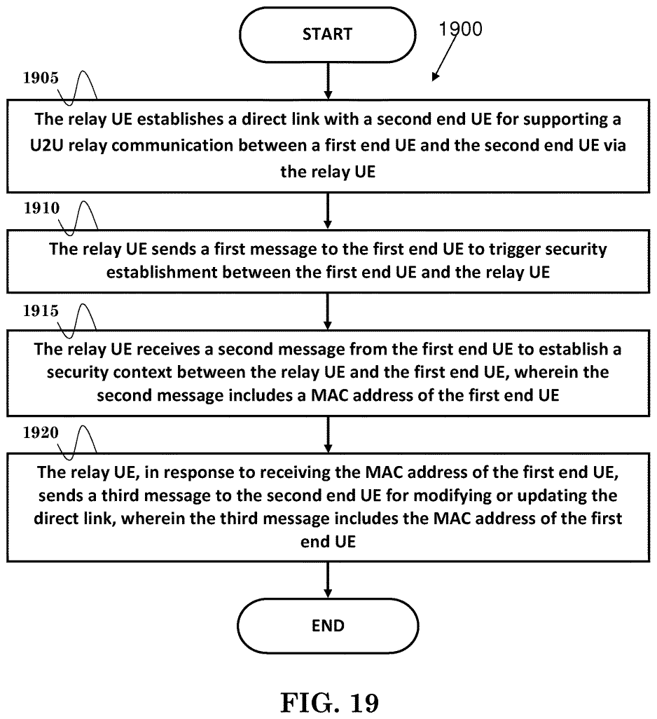

FIG. 19 is a flow chart 1900 for a relay User Equipment (UE). In step 1905, the relay UE establishes a direct link with a second end UE for supporting a U2U relay communication between a first end UE and the second end UE via the relay UE. In step 1910, the relay UE sends a first message to the first end UE to trigger security establishment between the first end UE and the relay UE. In step 1915, the relay UE receives a second message from the first end UE to establish a security context between the relay UE and the first end UE, wherein the second message includes a MAC address of the first end UE. In step 1920, the relay UE, in response to receiving the MAC address of the first end UE, sends a third message to the second end UE for modifying or updating the direct link, wherein the third message includes the MAC address of the first end UE.

In one embodiment, the relay UE could receive a request message of a link establishment procedure for supporting the U2U relay communication from the first end UE. The request message could be used for 5G ProSe UE-to-UE Relay Communication with integrated discovery. The request message may include a relay_indication. The request message may not include information used to identifying any UE-to-UE Relay.

In one embodiment, the third message could include information used to provide PC5 QoS related information to the target end UE. The third message could be sent to the target end UE during the link establishment procedure or before sending an accept message corresponding to the request message to the source end UE.

In one embodiment, the first message may be a PROSE DIRECT LINK SECURITY MODE COMMAND message. The second message may be a PROSE DIRECT LINK SECURITY MODE COMPLETE message. The third message may be a Link Modification Request message or a PROSE DIRECT LINK MODIFICATION REQUEST message.

In one embodiment, the request message could be a Direct Communication Request message or a PROSE DIRECT LINK ESTABLISHMENT REQUEST message. The accept message could be a Direct Communication Accept message or a PROSE DIRECT LINK ESTABLISHMENT ACCEPT message.

In one embodiment, the direct link may be a PC5 connection, PC5-S connection, PC5-RRC connection, or layer-2 link. The first end UE may be a source 5G ProSe (layer-3) End UE. The second end UE may be a target 5G ProSe (layer-3) End UE. The relay UE may be a 5G ProSe (layer-3) UE-to-UE relay UE.

Referring back to FIGS. 3 and 4, in one exemplary embodiment from the perspective of a relay UE. The relay UE 300 includes a program code 312 stored in the memory 310. The CPU 308 could execute program code 312 to enable the relay UE (i) to establish a direct link with a second end UE for supporting a U2U relay communication between a first end UE and the second end UE via the relay UE, (ii) to send a first message to the first end UE to trigger security establishment between the first end UE and the relay UE, (iii) to receive a second message from the first end UE to establish a security context between the relay UE and the first end UE, wherein the second message includes a MAC address of the first end UE, and (iv) to send, in response to receiving the MAC address of the first end UE, a third message to the second end UE for modifying or updating the direct link, wherein the third message includes the MAC address of the first end UE. Furthermore, the CPU 308 can execute the program code 312 to perform all of the above-described actions and steps or others described herein.

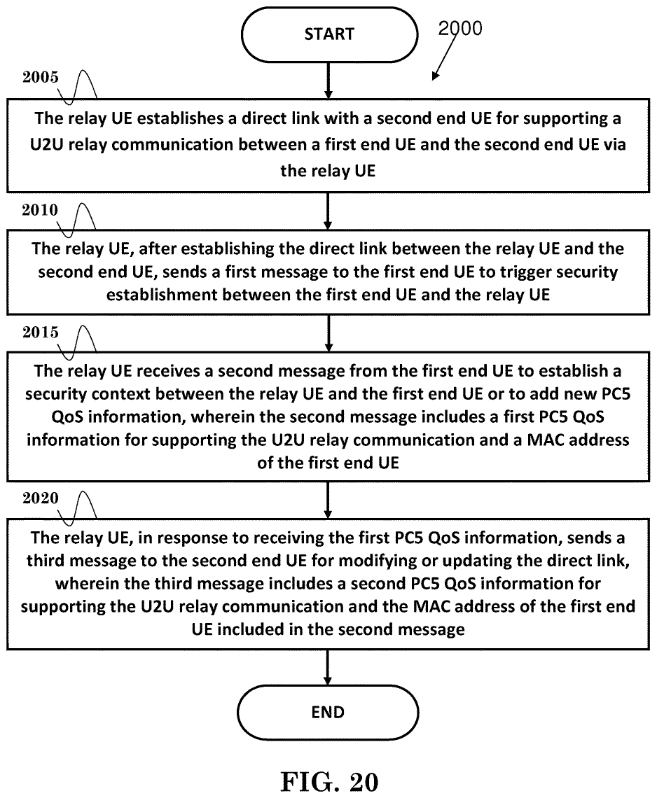

FIG. 20 is a flow chart 2000 for a relay User Equipment (UE). In step 2005, the relay UE establishes a direct link with a second end UE for supporting a U2U relay communication between a first end UE and the second end UE via the relay UE. In step 2010, the relay UE, after establishing the direct link between the relay UE and the second end UE, sends a first message to the first end UE to trigger security establishment between the first end UE and the relay UE. In step 2015, the relay UE receives a second message from the first end UE to establish a security context between the relay UE and the first end UE or to add new PC5 Quality of Service (QoS) information, wherein the second message includes a first PC5 QoS information for supporting the U2U relay communication and a MAC address of the first end UE. In step 2020, the relay UE, in response to receiving the first PC5 QoS information, sends a third message to the second end UE for modifying or updating the direct link, wherein the third message includes a second PC5 QOS information for supporting the U2U relay communication and the MAC address of the first end UE included in the second message.

In one embodiment, the relay UE could receive a request message of a link establishment procedure for supporting the U2U relay communication from the first end UE. The request message may include a relay indication indicating it is for 5G ProSe UE-to-UE Relay Communication with integrated discovery. The request message may not include information used to identifying any UE-to-UE Relay.

In one embodiment, the first message may be a PROSE DIRECT LINK SECURITY MODE COMMAND message, and the second message is a PROSE DIRECT LINK SECURITY MODE COMPLETE message. The third message may be a Link Modification Request message or a PROSE DIRECT LINK MODIFICATION REQUEST message. The third message may be sent in a link modification procedure to provide the MAC address of the first end UE to the second end UE.

In one embodiment, the request message may be a Direct Communication Request message or a PROSE DIRECT LINK ESTABLISHMENT REQUEST message, and the accept message is a Direct Communication Accept message or a PROSE DIRECT LINK ESTABLISHMENT ACCEPT message. The direct link may be a PC5 connection, PC5-S connection, PC5-RRC connection, or layer-2 link. The first end UE may be a source 5G ProSe End UE. The second end UE may be a target 5G ProSe End UE. The relay UE may be a 5G ProSe UE-to-UE relay UE.

Referring back to FIGS. 3 and 4, in one exemplary embodiment from the perspective of a relay UE. The relay UE 300 includes a program code 312 stored in the memory 310. The CPU 308 could execute program code 312 to enable the relay UE (i) to establish a direct link with a second end UE for supporting a U2U relay communication between a first end UE and the second end UE via the relay UE, (ii) to send, after establishing the direct link between the relay UE and the second end UE, a first message to the first end UE to trigger security establishment between the first end UE and the relay UE, (iii) to receive a second message from the first end UE to establish a security context between the relay UE and the first end UE or to add new PC5 QoS information, wherein the second message includes a first PC5 QoS information for supporting the U2U relay communication and a MAC address of the first end UE, and (iv) to send, in response to receiving the first PC5 QoS information, a third message to the second end UE for modifying or updating the direct link, wherein the third message includes a second PC5 QoS information for supporting the U2U relay communication and the MAC address of the first end UE included in the second message. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a relay User Equipment (UE), comprising:
the relay UE establishes a direct link with a second end UE for supporting a UE-to-UE (U2U) relay communication between a first end UE and the second end UE via the relay UE;
the relay UE, after establishing the direct link between the relay UE and the second end UE, sends a first message to the first end UE to trigger security establishment between the first end UE and the relay UE;
the relay UE receives a second message from the first end UE to establish a security context between the relay UE and the first end UE or to add new PC5 Quality of Service (QoS) information, wherein the second message includes a first PC5 QoS information for supporting the U2U relay communication and a Medium Access Control (MAC) address of the first end UE; and
the relay UE, in response to receiving the first PC5 QoS information, sends a third message to the second end UE for modifying or updating the direct link, wherein the third message includes a second PC5 QoS information for supporting the U2U relay communication and the MAC address of the first end UE included in the second message.

2. The method of claim 1, further comprising:
the relay UE receives a request message of a link establishment procedure for supporting the U2U relay communication from the first end UE.

3. The method of claim 2, wherein the request message includes a relay indication indicating it is for 5G Proximity-based services (ProSe) UE-to-UE Relay Communication with integrated discovery.

4. The method of claim 2, wherein the request message does not include information used to identifying any UE-to-UE Relay.

5. The method of claim 1, wherein the first message is a PROSE DIRECT LINK SECURITY MODE COMMAND message, and the second message is a PROSE DIRECT LINK SECURITY MODE COMPLETE message.

6. The method of claim 1, wherein the third message is a Link Modification Request message or a PROSE DIRECT LINK MODIFICATION REQUEST message.

7. The method of claim 1, wherein the third message is sent in a link modification procedure to provide the MAC address of the first end UE to the second end UE.

8. The method of claim 2, wherein the request message is a Direct Communication Request message or a PROSE DIRECT LINK ESTABLISHMENT REQUEST message, and the accept message is a Direct Communication Accept message or a PROSE DIRECT LINK ESTABLISHMENT ACCEPT message.

9. The method of claim 1, wherein the direct link is a PC5 connection, PC5-S connection, PC5-RRC connection, or layer-2 link.

10. The method of claim 1, wherein the first end UE is a source 5G ProSe End UE, the second end UE is a target 5G ProSe End UE, and the relay UE is a 5G ProSe UE-to-UE relay UE.

11. A relay User Equipment (UE), comprising:
a control circuit;
a processor installed in the control circuit;
a memory installed in the control circuit and coupled to the processor;
wherein the processor is configured to execute a program code stored in the memory to:
establish a direct link with a second end UE for supporting a UE-to-UE (U2U) relay communication between a first end UE and the second end UE via the relay UE;
send, after establishing the direct link between the relay UE and the second end UE, a first message to the first end UE to trigger security establishment between the first end UE and the relay UE;
receive a second message from the first end UE to establish a security context between the relay UE and the first end UE or to add new PC5 Quality of Service (QoS) information, wherein the second message includes a first PC5 QoS information for supporting the U2U relay communication and a Medium Access Control (MAC) address of the first end UE; and
send, in response to receiving the first PC5 QoS information, a third message to the second end UE for modifying or updating the direct link, wherein the third message includes a second PC5 QoS information for supporting the U2U relay communication and the MAC address of the first end UE included in the second message.

12. The relay UE of claim 11, wherein the processor is configured to execute a program code stored in the memory to:
receive a request message of a link establishment procedure for supporting the U2U relay communication from the first end UE.

13. The relay UE of claim 12, wherein the request message includes a relay indication indicating it is for 5G Proximity-based services (ProSe) UE-to-UE Relay Communication with integrated discovery.

14. The relay UE of claim 12, wherein the request message does not include information used to identifying any UE-to-UE Relay.

15. The relay UE of claim 11, wherein the first message is a PROSE DIRECT LINK SECURITY MODE COMMAND message, and the second message is a PROSE DIRECT LINK SECURITY MODE COMPLETE message.

16. The relay UE of claim 11, wherein the third message is a Link Modification Request message or a PROSE DIRECT LINK MODIFICATION REQUEST message.

17. The relay UE of claim 11, wherein the third message is sent in a link modification procedure to provide the MAC address of the first end UE to the second end UE.

18. The relay UE of claim 12, wherein the request message is a Direct Communication Request message or a PROSE DIRECT LINK ESTABLISHMENT REQUEST message, and the accept message is a Direct Communication Accept message or a PROSE DIRECT LINK ESTABLISHMENT ACCEPT message.

19. The relay UE of claim 11, wherein the direct link is a PC5 connection, PC5-S connection, PC5-RRC connection, or layer-2 link.

20. The relay UE of claim 11, wherein the first end UE is a source 5G ProSe End UE, the second end UE is a target 5G ProSe End UE, and the relay UE is a 5G ProSe UE-to-UE relay UE.
